(19) United States
(12) Patent Application Publication
(10) Pub. No.: US 2025/0130329 A1
(43) Pub. Date: Apr. 24, 2025

(54) DYNAMIC OCCUPANCY GRID WITH CAMERA INTEGRATION

(71) Applicant: QUALCOMM Incorporated, San Diego, CA (US)

(72) Inventors: Makesh Pravin JOHN WILSON, San Diego, CA (US); Vishnuu APPAYA DHANABALAN, Munich (DE); Volodimir SLOBODYANYUK, San Diego, CA (US); Avdhut JOSHI, San Marcos, CA (US); Radhika Dilip GOWAIKAR, San Diego, CA (US)

(21) Appl. No.: 18/812,289

(22) Filed: Aug. 22, 2024

Related U.S. Application Data
(60) Provisional application No. 63/592,709, filed on Oct. 24, 2023.

(51) Int. Cl. G01S 13/931; G01S 13/72; G01S 13/89

(52) U.S. Cl. CPC G01S 13/931; G01S 13/726; G01S 13/89

(57) ABSTRACT

A dynamic occupancy grid determination method includes: obtaining, at an apparatus, at least one radar-based occupancy grid based on radar sensor measurements, each of the at least one radar-based occupancy grid comprising a plurality of first cells, each cell of the plurality of first cells having a corresponding first occupancy probability and first velocity; obtaining, at the apparatus, at least one camera-based occupancy grid based on camera measurements, each of the at least one camera-based occupancy grid comprising a plurality of second cells, each cell of the plurality of second cells having a corresponding second occupancy probability and second velocity; and determining, at the apparatus, a dynamic occupancy grid by analyzing the at least one radar-based occupancy grid and the at least one camera-based occupancy grid.

### CROSS-REFERENCE TO RELATED APPLICATIONS

This application claims the benefit of U.S. Provisional Application No. 63/592,709, filed Oct. 24, 2023, entitled “DYNAMIC OCCUPANCY GRID WITH CAMERA INTEGRATION,” which is assigned to the assignee hereof, and the entire contents of which are hereby incorporated herein by reference for all purposes.

### BACKGROUND

Vehicles are becoming more intelligent as the industry moves towards deploying increasingly sophisticated self-driving technologies that are capable of operating a vehicle with little or no human input, and thus being semi-autonomous or autonomous. Autonomous and semi-autonomous vehicles may be able to detect information about their location and surroundings (e.g., using ultrasound, radar, lidar, an SPS (Satellite Positioning System), and/or an odometer, and/or one or more sensors such as accelerometers, cameras, etc.). Autonomous and semi-autonomous vehicles typically include a control system to interpret information regarding an environment in which the vehicle is disposed to identify hazards and determine a navigation path to follow.

A driver assistance system may mitigate driving risk for a driver of an ego vehicle (i.e., a vehicle configured to perceive the environment of the vehicle) and/or for other road users. Driver assistance systems may include one or more active devices and/or one or more passive devices that can be used to determine the environment of the ego vehicle and, for semi-autonomous vehicles, possibly to notify a driver of a situation that the driver may be able to address. The driver assistance system may be configured to control various aspects of driving safety and/or driver monitoring. For example, a driver assistance system may control a speed of the ego vehicle to maintain at least a desired separation (in distance or time) between the ego vehicle and another vehicle (e.g., as part of an active cruise control system). The driver assistance system may monitor the surroundings of the ego vehicle, e.g., to maintain situational awareness for the ego vehicle. The situational awareness may be used to notify the driver of issues, e.g., another vehicle being in a blind spot of the driver, another vehicle being on a collision path with the ego vehicle, etc. The situational awareness may include information about the ego vehicle (e.g., speed, location, heading) and/or information about other vehicles or objects (e.g., location, speed, heading, size, object type, etc.).

A state of an ego vehicle may be used as an input to a number of driver assistance functionalities, such as an Advanced Driver Assistance System (ADAS). Downstream driving aids such as an ADAS may be safety critical, and/or may give the driver of the vehicle information and/or control the vehicle in some way.

### SUMMARY

An example apparatus includes: at least one memory; and at least one processor communicatively coupled to the at least one memory and configured to: obtain at least one radar-based occupancy grid based on radar sensor measurements, each of the at least one radar-based occupancy grid comprising a plurality of first cells, each cell of the plurality of first cells having a corresponding first occupancy probability and first velocity; obtain at least one camera-based occupancy grid based on camera measurements, each of the at least one camera-based occupancy grid comprising a plurality of second cells, each cell of the plurality of second cells having a corresponding second occupancy probability and second velocity; and determine a dynamic occupancy grid by analyzing the at least one radar-based occupancy grid and the at least one camera-based occupancy grid.

An example dynamic occupancy grid determination method includes: obtaining, at an apparatus, at least one radar-based occupancy grid based on radar sensor measurements, each of the at least one radar-based occupancy grid comprising a plurality of first cells, each cell of the plurality of first cells having a corresponding first occupancy probability and first velocity; obtaining, at the apparatus, at least one camera-based occupancy grid based on camera measurements, each of the at least one camera-based occupancy grid comprising a plurality of second cells, each cell of the plurality of second cells having a corresponding second occupancy probability and second velocity; and determining, at the apparatus, a dynamic occupancy grid by analyzing the at least one radar-based occupancy grid and the at least one camera-based occupancy grid.

Another example apparatus includes: means for obtaining at least one radar-based occupancy grid based on radar sensor measurements, each of the at least one radar-based occupancy grid comprising a plurality of first cells, each cell of the plurality of first cells having a corresponding first occupancy probability and first velocity; means for obtaining at least one camera-based occupancy grid based on camera measurements, each of the at least one camera-based occupancy grid comprising a plurality of second cells, each cell of the plurality of second cells having a corresponding second occupancy probability and second velocity; and means for determining a dynamic occupancy grid by analyzing the at least one radar-based occupancy grid and the at least one camera-based occupancy grid.

An example non-transitory, processor-readable storage medium includes processor-readable instructions to cause a processor of an apparatus to: obtain at least one radar-based occupancy grid based on radar sensor measurements, each of the at least one radar-based occupancy grid comprising a plurality of first cells, each cell of the plurality of first cells having a corresponding first occupancy probability and first velocity; obtain at least one camera-based occupancy grid based on camera measurements, each of the at least one camera-based occupancy grid comprising a plurality of second cells, each cell of the plurality of second cells having a corresponding second occupancy probability and second velocity; and determine a dynamic occupancy grid by analyzing the at least one radar-based occupancy grid and the at least one camera-based occupancy grid.

### BRIEF DESCRIPTION OF THE DRAWINGS

FIG. 1 is a top view of an example ego vehicle.

FIG. 2 is a block diagram of components of an example device, of which the ego vehicle shown in FIG. 1 may be an example.

FIG. 3 is a block diagram of components of an example transmission/reception point.

FIG. 4 is a block diagram of components of a server.

FIG. 5 is a block diagram of an example device.

FIG. 6 is a diagram of an example geographic environment.

FIG. 7 is a diagram of the geographic environment shown in FIG. 6 divided into a grid.

FIG. 8 is an example of an occupancy map corresponding to the grid shown in FIG. 7.

FIG. 9 is a block diagram of an example method of dynamic grid clustering.

FIG. 10 is a block diagram of an example functional architecture of an environment modeling block of the device shown in FIG. 5.

FIG. 11 is a block diagram of an example method of fusing radar and camera sensor data to determine a measurement grid.

FIG. 12 is another block diagram of another example method of fusing radar and camera sensor data to determine a measurement grid.

FIG. 13 is another block diagram of another example method of fusing radar and camera sensor data to determine a measurement grid.

FIG. 14 is a block diagram of a message flow of message information for a camera of the device shown in FIG. 5.

FIG. 15 is a block flow diagram of an example dynamic occupancy grid determination method.

### DETAILED DESCRIPTION

Techniques are discussed herein for determining and using occupancy grids. For example, measurements from multiple sensors, including one or more radars and a camera, may be obtained and measurements therefrom used to determine a dynamic occupancy grid. Techniques are discussed for incorporating camera data in determining a dynamic occupancy grid, e.g., determining velocity values for grid cells, fusing camera data with radar data to determine the velocity values, determining static versus dynamic mass values for grid cells, etc. Fusing of camera data and radar data may comprise assessing corresponding cells of multiple occupancy grids to determine one or more values (e.g., one or more probabilities, a velocity, etc.) for a cell of a fused grid. Other techniques, however, may be used.

Items and/or techniques described herein may provide one or more of the following capabilities, as well as other capabilities not mentioned. Occupancy grid accuracy and/or reliability may be improved. Autonomous driving actions and/or autonomous driving safety may be improved, e.g., due to improved occupancy grid accuracy and/or reliability. Tracking of vehicles stopping and starting at intersections may be improved. Other capabilities may be provided and not every implementation according to the disclosure must provide any, let alone all, of the capabilities discussed.

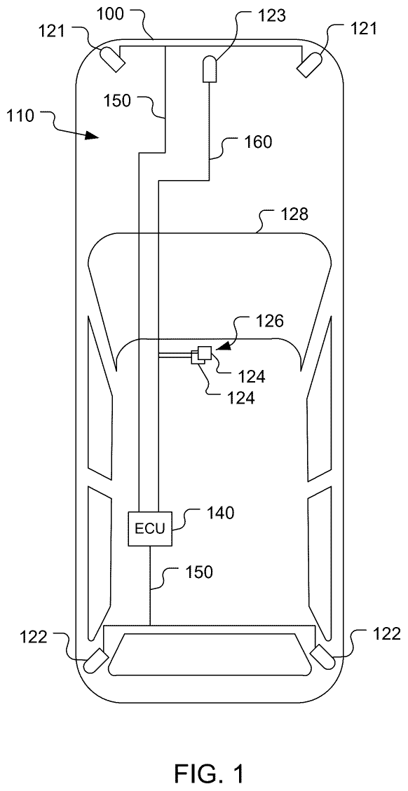

Referring to FIG. 1, an ego vehicle 100 includes an ego vehicle driver assistance system 110. The driver assistance system 110 may include a number of different types of sensors mounted at appropriate positions on the ego vehicle 100. For example, the system 110 may include: a pair of divergent and outwardly directed radar sensors 121 mounted at respective front corners of the vehicle 100, a similar pair of divergent and outwardly directed radar sensors 122 mounted at respective rear corners of the vehicle 100, a forwardly directed LRR sensor 123 (Long-Range Radar) mounted centrally at the front of the vehicle 100, and a pair of generally forwardly directed optical sensors 124 (cameras) forming part of an SVS 126 (Stereo Vision System) which may be mounted, for example, in the region of an upper edge of a windshield 128 of the vehicle 100. Each of the sensors 121, 122 may include an LRR and/or an SRR (Short-Range Radar). The various sensors 121-124 may be operatively connected to a central electronic control system which is typically provided in the form of an ECU 140 (Electronic Control Unit) mounted at a convenient location within the vehicle 100. In the particular arrangement illustrated, the front and rear sensors 121, 122 are connected to the ECU 140 via one or more conventional Controller Area Network (CAN) buses 150, and the LRR sensor 123 and the sensors of the SVS 126 are connected to the ECU 140 via a serial bus 160 (e.g., a faster FlexRay serial bus).

Collectively, and under the control of the ECU 140, the various sensors 121-124 may be used to provide a variety of different types of driver assistance functionalities. For example, the sensors 121-124 and the ECU 140 may provide blind spot monitoring, adaptive cruise control, collision prevention assistance, lane departure protection, and/or rear collision mitigation.

The CAN bus 150 may be treated by the ECU 140 as a sensor that provides ego vehicle parameters to the ECU 140. For example, a GPS module may also be connected to the ECU 140 as a sensor, providing geolocation parameters to the ECU 140.

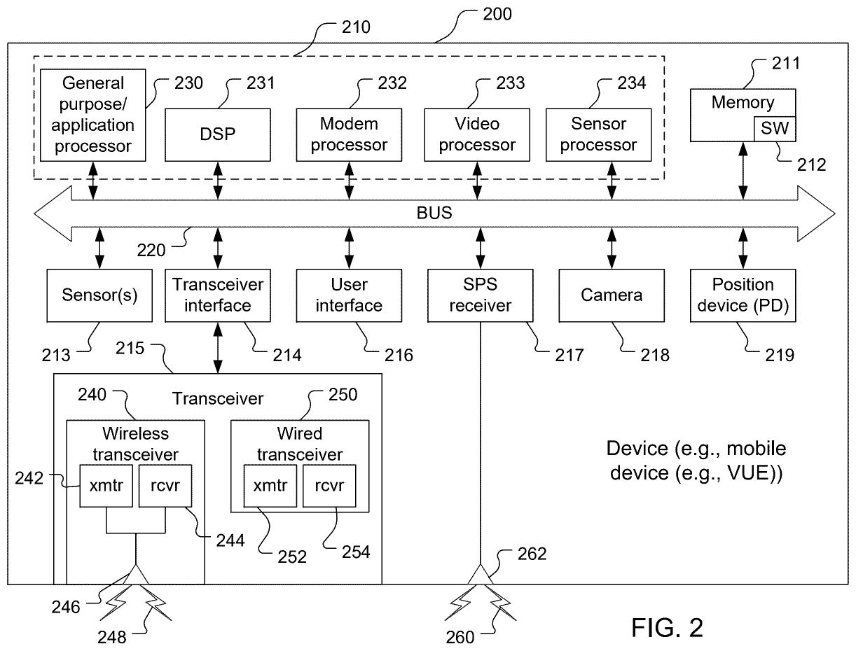

Referring also to FIG. 2, a device 200 (which may be a mobile device such as a user equipment (UE) such as a vehicle (VUE)) comprises a computing platform including a processor 210, memory 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, a camera 218, and a position device (PD) 219. The terms “user equipment” or “UE” (or variations thereof) are not specific to or otherwise limited to any particular Radio Access Technology (RAT), unless otherwise noted. The processor 210, the memory 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the device 200. The processor 210 may include one or more hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more (cellular) wireless signals transmitted and reflection(s) used to identify, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the device 200 for connectivity. The memory 211 may be a non-transitory, processor-readable storage medium that may include random access memory (RAM), flash memory, disc memory, and/or read-only memory (ROM), etc. The memory 211 may store the software 212 which may be processor-readable, processor-executable software code containing instructions that may be configured to, when executed, cause the processor 210 to perform various functions described herein. Alternatively, the software 212 may not be directly executable by the processor 210 but may be configured to cause the processor 210, e.g., when compiled and executed, to perform the functions. The description herein may refer to the processor 210 performing a function, but this includes other implementations such as where the processor 210 executes instructions of software and/or firmware. The description herein may refer to the processor 210 performing a function as shorthand for one or more of the processors 230-234 performing the function. The description herein may refer to the device 200 performing a function as shorthand for one or more appropriate components of the device 200 performing the function. The processor 210 may include a memory with stored instructions in addition to and/or instead of the memory 211. Functionality of the processor 210 is discussed more fully below.

The configuration of the device 200 shown in FIG. 2 is an example and not limiting of the disclosure, including the claims, and other configurations may be used. For example, an example configuration of the UE may include one or more of the processors 230-234 of the processor 210, the memory 211, and the wireless transceiver 240. Other example configurations may include one or more of the processors 230-234 of the processor 210, the memory 211, a wireless transceiver, and one or more of the sensor(s) 213, the user interface 216, the SPS receiver 217, the camera 218, the PD 219, and/or a wired transceiver.

The device 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the general-purpose/application processor 230 and/or the DSP 231. Other configurations, however, may be used to perform baseband processing.

The device 200 may include the sensor(s) 213 that may include, for example, one or more of various types of sensors such as one or more inertial sensors, one or more magnetometers, one or more environment sensors, one or more optical sensors, one or more weight sensors, and/or one or more radio frequency (RF) sensors, etc. An inertial measurement unit (IMU) may comprise, for example, one or more accelerometers (e.g., collectively responding to acceleration of the device 200 in three dimensions) and/or one or more gyroscopes (e.g., three-dimensional gyroscope(s)). The sensor(s) 213 may include one or more magnetometers (e.g., three-dimensional magnetometer(s)) to determine orientation (e.g., relative to magnetic north and/or true north) that may be used for any of a variety of purposes, e.g., to support one or more compass applications. The environment sensor(s) may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the general-purpose/application processor 230 in support of one or more applications such as, for example, applications directed to positioning and/or navigation operations.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the device 200 is fixed (stationary) or mobile and/or whether to report certain useful information, e.g., to an LMF (Location Management Function) regarding the mobility of the device 200. For example, based on the information obtained/measured by the sensor(s) 213, the device 200 may notify/report to the LMF that the device 200 has detected movements or that the device 200 has moved, and may report the relative displacement/distance (e.g., via dead reckoning, or sensor-based location determination, or sensor-assisted location determination enabled by the sensor(s) 213). In another example, for relative positioning information, the sensors/IMU may be used to determine the angle and/or orientation of another object (e.g., another device) with respect to the device 200, etc.

The IMU may be configured to provide measurements about a direction of motion and/or a speed of motion of the device 200, which may be used in relative location determination. For example, one or more accelerometers and/or one or more gyroscopes of the IMU may detect, respectively, a linear acceleration and a speed of rotation of the device 200. The linear acceleration and speed of rotation measurements of the device 200 may be integrated over time to determine an instantaneous direction of motion as well as a displacement of the device 200. The instantaneous direction of motion and the displacement may be integrated to track a location of the device 200. For example, a reference location of the device 200 may be determined, e.g., using the SPS receiver 217 (and/or by some other means) for a moment in time and measurements from the accelerometer(s) and gyroscope(s) taken after this moment in time may be used in dead reckoning to determine present location of the device 200 based on movement (direction and distance) of the device 200 relative to the reference location.

The magnetometer(s) may determine magnetic field strengths in different directions which may be used to determine orientation of the device 200. For example, the orientation may be used to provide a digital compass for the device 200. The magnetometer(s) may include a two-dimensional magnetometer configured to detect and provide indications of magnetic field strength in two orthogonal dimensions. The magnetometer(s) may include a three-dimensional magnetometer configured to detect and provide indications of magnetic field strength in three orthogonal dimensions. The magnetometer(s) may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to an antenna 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to guided (e.g., wired electrical and/or optical) signals and from guided (e.g., wired electrical and/or optical) signals to the wireless signals 248. The wireless transmitter 242 includes appropriate components (e.g., a power amplifier and a digital-to-analog converter). The wireless receiver 244 includes appropriate components (e.g., one or more amplifiers, one or more frequency filters, and an analog-to-digital converter). The wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi® short-range wireless communication technology, WiFi® Direct (WiFi-D), Bluetooth® short-range wireless communication technology, Zigbee® short-range wireless communication technology, etc. New Radio may use mm-wave frequencies and/or sub-6 GHZ frequencies. The wired transceiver 250 may include a wired transmitter 252 and a wired receiver 254 configured for wired communication, e.g., a network interface that may be utilized to communicate with an NG-RAN (Next Generation-Radio Access Network) to send communications to, and receive communications from, the NG-RAN. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215. The wireless transmitter 242, the wireless receiver 244, and/or the antenna 246 may include multiple transmitters, multiple receivers, and/or multiple antennas, respectively, for sending and/or receiving, respectively, appropriate signals.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the device 200. For example, the user interface 216 may store indications of analog and/or digital signals in the memory 211 to be processed by DSP 231 and/or the general-purpose/application processor 230 in response to action from a user. Similarly, applications hosted on the device 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The SPS antenna 262 is configured to transduce the SPS signals 260 from wireless signals to guided signals, e.g., wired electrical or optical signals, and may be integrated with the antenna 246. The SPS receiver 217 may be configured to process, in whole or in part, the acquired SPS signals 260 for estimating a location of the device 200. For example, the SPS receiver 217 may be configured to determine location of the device 200 by trilateration using the SPS signals 260. The general-purpose/application processor 230, the memory 211, the DSP 231 and/or one or more specialized processors (not shown) may be utilized to process acquired SPS signals, in whole or in part, and/or to calculate an estimated location of the device 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose/application processor 230, the DSP 231, and/or one or more specialized processors, and/or the memory 211 may provide or support a location engine for use in processing measurements to estimate a location of the device 200.

The device 200 may include the camera 218 for capturing still or moving imagery. The camera 218 may comprise, for example, an imaging sensor (e.g., a charge coupled device or a CMOS (Complementary Metal-Oxide Semiconductor) imager), a lens, analog-to-digital circuitry, frame buffers, etc. Additional processing, conditioning, encoding, and/or compression of signals representing captured images may be performed by the general-purpose/application processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position device (PD) 219 may be configured to determine a position of the device 200, motion of the device 200, and/or relative position of the device 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer to the PD 219 being configured to perform, or performing, in accordance with the positioning method(s). The PD 219 may also or alternatively be configured to determine location of the device 200 using terrestrial-based signals (e.g., at least some of the wireless signals 248) for trilateration, for assistance with obtaining and using the SPS signals 260, or both. The PD 219 may be configured to determine location of the device 200 based on a coverage area of a serving base station and/or another technique such as E-CID. The PD 219 may be configured to use one or more images from the camera 218 and image recognition combined with known locations of landmarks (e.g., natural landmarks such as mountains and/or artificial landmarks such as buildings, bridges, streets, etc.) to determine location of the device 200. The PD 219 may be configured to use one or more other techniques (e.g., relying on the UE's self-reported location (e.g., part of the UE's position beacon)) for determining the location of the device 200, and may use a combination of techniques (e.g., SPS and terrestrial positioning signals) to determine the location of the device 200. The PD 219 may include one or more of the sensors 213 (e.g., gyroscope(s), accelerometer(s), magnetometer(s), etc.) that may sense orientation and/or motion of the device 200 and provide indications thereof that the processor 210 (e.g., the general-purpose/application processor 230 and/or the DSP 231) may be configured to use to determine motion (e.g., a velocity vector and/or an acceleration vector) of the device 200. The PD 219 may be configured to provide indications of uncertainty and/or error in the determined position and/or motion. Functionality of the PD 219 may be provided in a variety of manners and/or configurations, e.g., by the general-purpose/application processor 230, the transceiver 215, the SPS receiver 217, and/or another component of the device 200, and may be provided by hardware, software, firmware, or various combinations thereof.

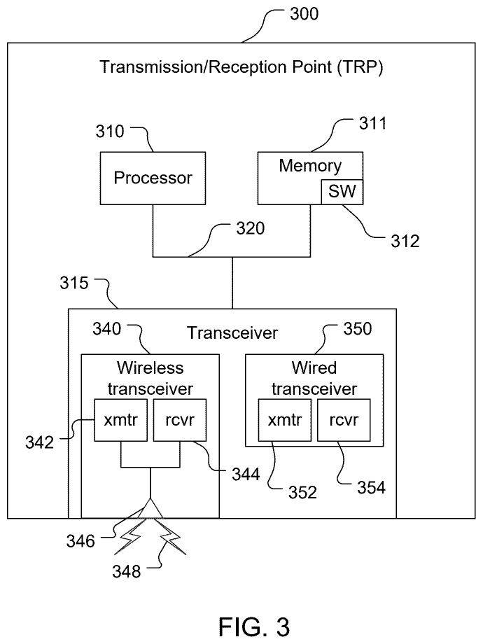

Referring also to FIG. 3, an example of a TRP 300 (e.g., of a base station such as a gNB (general NodeB) and/or an ng-eNB (next generation evolved NodeB) may comprise a computing platform including a processor 310, memory 311 including software (SW) 312, and a transceiver 315. Even if referred to in the singular, the processor 310 may include one or more processors, the transceiver 315 may include one or more transceivers (e.g., one or more transmitters and/or one or more receivers), and/or the memory 311 may include one or more memories. The processor 310, the memory 311, and the transceiver 315 may be communicatively coupled to each other by a bus 320 (which may be configured, e.g., for optical and/or electrical communication). One or more of the shown apparatus (e.g., a wireless transceiver) may be omitted from the TRP 300. The processor 310 may include one or more hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 may be a non-transitory storage medium that may include random access memory (RAM)), flash memory, disc memory, and/or read-only memory (ROM), etc. The memory 311 may store the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions.

The description herein may refer to the processor 310 performing a function, but this includes other implementations such as where the processor 310 executes software and/or firmware. The description herein may refer to the processor 310 performing a function as shorthand for one or more of the processors contained in the processor 310 performing the function. The description herein may refer to the TRP 300 performing a function as shorthand for one or more appropriate components (e.g., the processor 310 and the memory 311) of the TRP 300 performing the function. The processor 310 may include a memory with stored instructions in addition to and/or instead of the memory 311. Functionality of the processor 310 is discussed more fully below.

The transceiver 315 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to guided (e.g., wired electrical and/or optical) signals and from guided (e.g., wired electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with the device 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi® short-range wireless communication technology, WiFi® Direct (WiFi®-D), Bluetooth® short-range wireless communication technology, Zigbee® short-range wireless communication technology, etc. The wired transceiver 350 may include a wired transmitter 352 and a wired receiver 354 configured for wired communication, e.g., a network interface that may be utilized to communicate with an NG-RAN to send communications to, and receive communications from, an LMF, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 may be configured to perform or performs several functions, but one or more of these functions may be performed by an LMF and/or the device 200 (i.e., an LMF and/or the device 200 may be configured to perform one or more of these functions).

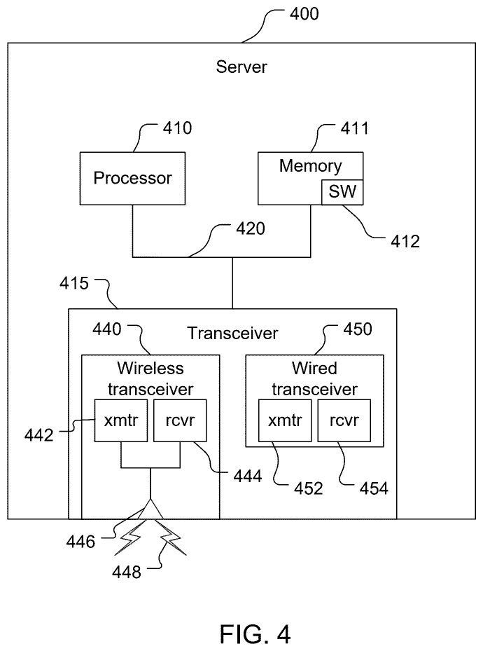

Referring also to FIG. 4, a server 400, of which an LMF is an example, may comprise a computing platform including a processor 410, memory 411 including software (SW) 412, and a transceiver 415. Even if referred to in the singular, the processor 410 may include one or more processors, the transceiver 415 may include one or more transceivers (e.g., one or more transmitters and/or one or more receivers), and/or the memory 411 may include one or more memories. The processor 410, the memory 411, and the transceiver 415 may be communicatively coupled to each other by a bus 420 (which may be configured, e.g., for optical and/or electrical communication). One or more of the shown apparatus (e.g., a wireless transceiver) may be omitted from the server 400. The processor 410 may include one or more hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 may be a non-transitory storage medium that may include random access memory (RAM)), flash memory, disc memory, and/or read-only memory (ROM), etc. The memory 411 may store the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description herein may refer to the processor 410 performing a function, but this includes other implementations such as where the processor 410 executes software and/or firmware. The description herein may refer to the processor 410 performing a function as shorthand for one or more of the processors contained in the processor 410 performing the function. The description herein may refer to the server 400 performing a function as shorthand for one or more appropriate components of the server 400 performing the function. The processor 410 may include a memory with stored instructions in addition to and/or instead of the memory 411. Functionality of the processor 410 is discussed more fully below.

The transceiver 415 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to guided (e.g., wired electrical and/or optical) signals and from guided (e.g., wired electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with the device 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi® short-range wireless communication technology, WiFi® Direct (WiFi®-D), Bluetooth® short-range wireless communication technology, Zigbee® short-range wireless communication technology, etc. The wired transceiver 450 may include a wired transmitter 452 and a wired receiver 454 configured for wired communication, e.g., a network interface that may be utilized to communicate with an NG-RAN to send communications to, and receive communications from, the TRP 300, for example, and/or one or more other network entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The description herein may refer to the processor 410 performing a function, but this includes other implementations such as where the processor 410 executes software (stored in the memory 411) and/or firmware. The description herein may refer to the server 400 performing a function as shorthand for one or more appropriate components (e.g., the processor 410 and the memory 411) of the server 400 performing the function.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the device 200 (i.e., the TRP 300 and/or the device 200 may be configured to perform one or more of these functions).

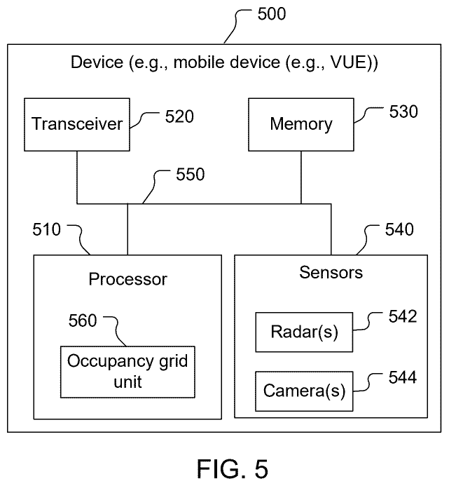

Referring to FIG. 5, a device 500 includes a processor 510, a transceiver 520, a memory 530, and sensors 540, communicatively coupled to each other by a bus 550. Even if referred to in the singular, the processor 510 may include one or more processors, the transceiver 520 may include one or more transceivers (e.g., one or more transmitters and/or one or more receivers), and the memory 530 may include one or more memories. The device 500 may take any of a variety of forms such as a mobile device such as a vehicle UE (VUE). The device 500 may include the components shown in FIG. 5, and may include one or more other components such as any of those shown in FIG. 2 such that the device 200 may be an example of the device 500. For example, the processor 510 may include one or more of the components of the processor 210. The transceiver 520 may include one or more of the components of the transceiver 215, e.g., the wireless transmitter 242 and the antenna 246, or the wireless receiver 244 and the antenna 246, or the wireless transmitter 242, the wireless receiver 244, and the antenna 246. Also or alternatively, the transceiver 520 may include the wired transmitter 252 and/or the wired receiver 254. The memory 530 may be configured similarly to the memory 211, e.g., including software with processor-readable instructions configured to cause the processor 510 to perform functions. The sensors 540 include one or more radar sensors 542 and one or more cameras 544.

The description herein may refer to the processor 510 performing a function, but this includes other implementations such as where the processor 510 executes software (stored in the memory 530) and/or firmware. The description herein may refer to the device 500 performing a function as shorthand for one or more appropriate components (e.g., the processor 510 and the memory 530) of the device 500 performing the function. The processor 510 (possibly in conjunction with the memory 530 and, as appropriate, the transceiver 520) may include an occupancy grid unit 560 (which may include an ADAS (Advanced Driver Assistance System) for a VUE). The occupancy grid unit 560 is discussed further herein, and the description herein may refer to the occupancy grid unit 560 performing one or more functions, and/or may refer to the processor 510 generally, or the device 500 generally, as performing any of the functions of the occupancy grid unit 560, with the device 500 being configured to perform the functions.

One or more functions performed by the device 500 (e.g., the occupancy grid unit 560) may be performed by another entity. For example, sensor measurements (e.g., radar measurements, camera measurements (e.g., pixels, images)) and/or processed sensor measurements (e.g., a camera image converted to a bird's-eye-view image) may be provided to another entity, e.g., the server 400, and the other entity may perform one or more functions discussed herein with respect to the occupancy grid unit 560 (e.g., using machine learning to determine a present occupancy grid and/or applying an observation model, analyzing measurements from different sensors, to determine a present occupancy grid, etc.).

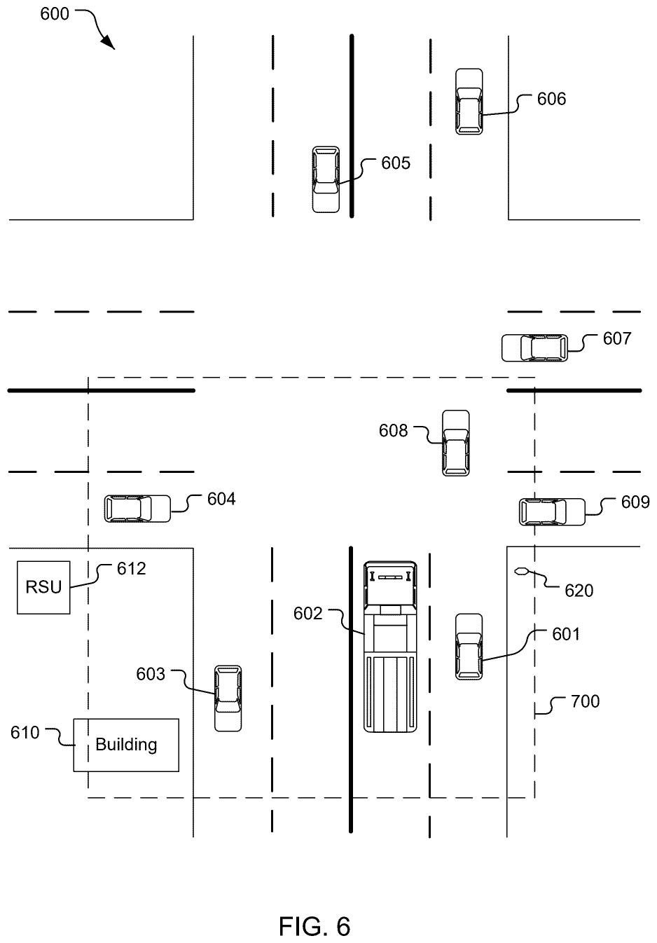

Referring also to FIG. 6, a geographic environment 600, in this example a driving environment, includes multiple mobile wireless communication devices, here vehicles 601, 602, 603, 604, 605, 606, 607, 608, 609, a building 610, an RSU 612 (Roadside Unit), and a street sign 620 (e.g., a stop sign). The RSU 612 may be configured similarly to the TRP 300, although perhaps having less functionality and/or shorter range than the TRP 300, e.g., a base-station-based TRP. One or more of the vehicles 601-609 may be configured to perform autonomous driving. A vehicle whose perspective is under consideration (e.g., for environment evaluation, autonomous driving, etc.) may be referred to as an observer vehicle or an ego vehicle. An ego vehicle, such as the vehicle 601 may evaluate a region around the ego vehicle for one or more desired purposes, e.g., to facilitate autonomous driving. The vehicle 601 may be an example of the device 500. The vehicle 601 may divide the region around the ego vehicle into multiple sub-regions and evaluate whether an object occupies each sub-region and if so, may determine one or more characteristics of the object (e.g., size, shape (e.g., dimensions (possibly including height)), velocity (speed and direction), object type or class (bicycle, car, truck, etc.), etc.).

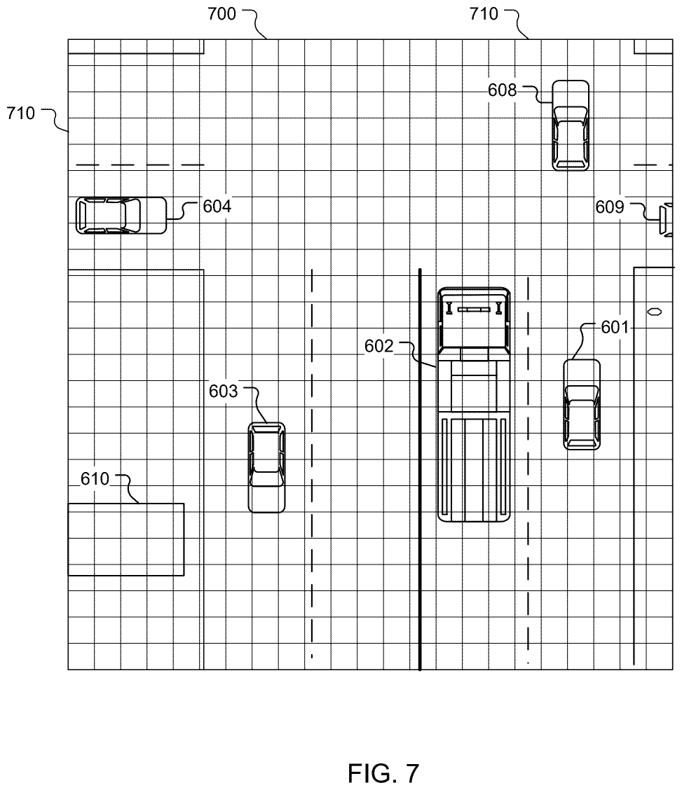

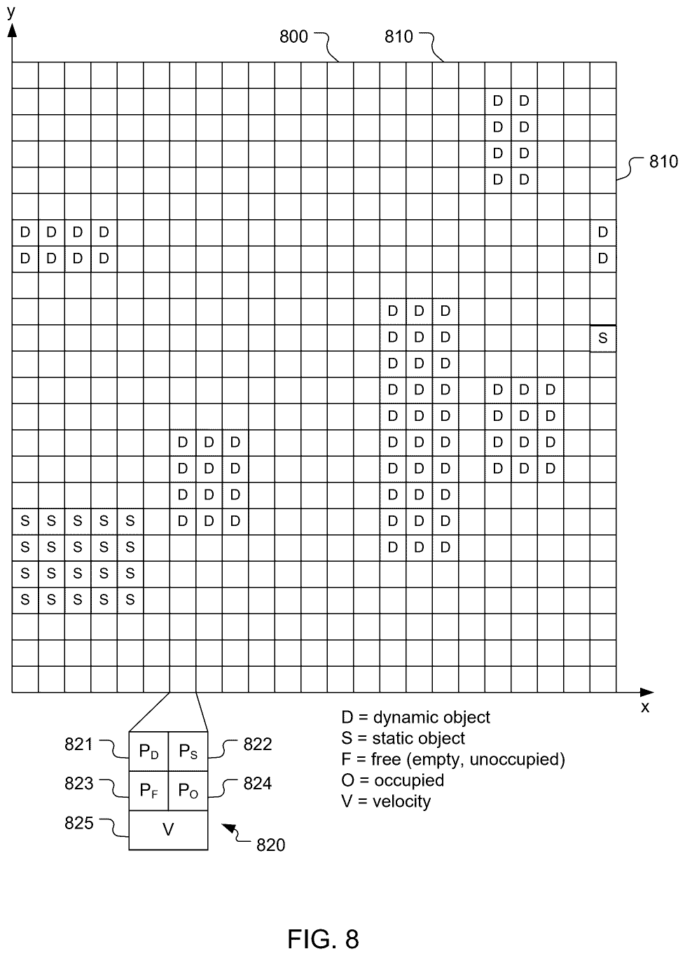

Referring also to FIGS. 7 and 8, a region 700, which in this example spans a portion of the environment 600, may be evaluated to determine an occupancy grid 800 (also called an occupancy map) that indicates multiple probabilities for each cell of the grid 800 whether the cell is occupied or free, and whether an occupying object is static or dynamic. For example, the region 700 may be divided into a grid, which may be called an occupancy grid, with sub-regions 710 that may be of similar (e.g., identical) size and shape, or may have two or more sizes and/or shapes (e.g., with sub-regions being smaller near an ego vehicle, e.g., the vehicle 601, and larger further away from the ego vehicle, and/or with sub-regions having different shape(s) near an ego vehicle than sub-region shape(s) further away from the ego vehicle). The region 700 and the grid 800 may be regularly-shaped (e.g., a rectangle, a triangle, a hexagon, an octagon, etc.) and/or may be divided into identically-shaped, regularly-shaped sub-regions for convenience sake, e.g., to simplify calculations, but other shapes of regions/grids (e.g., an irregular shape) and/or sub-regions (e.g., irregular shapes, multiple different regular shapes, or a combination of one or more irregular shapes and one or more regular shapes) may be used. For example, the sub-regions 710 may have rectangular (e.g., square) shapes. The region 700 may be of any of a variety of sizes and have any of a variety of granularities of sub-regions. For example, the region 700 may be a rectangle (e.g., a square) of about 100 m per side. As another example, while the region 700 is shown with the sub-regions 710 being squares of about 1 m per side, other sizes of sub-regions, including much smaller sub-regions, may be used. For example, square sub-regions of about 25 cm per side may be used. In this example, the region 700 is divided into M rows (here, 24 rows parallel to an x-axis indicated in FIG. 8) of N columns each (here, 23 columns parallel to a y-axis as indicated in FIG. 8). As another example, a grid may comprise a 512×512 array of sub-regions. Still other implementations of occupancy grids may be used.

Each of the sub-regions 710 may correspond to a respective cell 810 of the occupancy map and information may be obtained regarding what, if anything, occupies each of the sub-regions 710 and whether an occupying object is static or dynamic in order to populate cells 810 of the occupancy grid 800 with probabilities of the cell being occupied (O) or free (F) (i.e., unoccupied), and probabilities of an object at least partially occupying a cell being static(S) or dynamic (D). Each of the probabilities may be a floating point value. The information as to what, if anything, occupies each of the sub-regions 710 may be obtained from a variety of sources. For example, occupancy information may be obtained from sensor measurements from the sensors 540 of the device 500. As another example, occupancy information may be obtained by one or more other devices and communicated to the device 500. For example, one or more of the vehicles 602-609 may communicate, e.g., via C-V2X communications, occupancy information to the vehicle 601. As another example, the RSU 612 may gather occupancy information (e.g., from one or more sensors of the RSU 612 and/or from communication with one or more of the vehicles 602-609 and/or one or more other devices) and communicate the gathered information to the vehicle 601, e.g., directly and/or through one or more network entities, e.g., TRPs.

As shown in FIG. 8, each of the cells 810 may include a set 820 of occupancy information indicating a dynamic probability 821 (P_{D}), a static probability 822 (P_{S}), a free probability 823 (P_{F}), an occupied probability 824 (P_{P}), and a velocity 825 (V). The dynamic probability 821 indicates a probability that an object (if any) in the corresponding sub-region 710 is dynamic. The static probability 822 indicates a probability that an object (if any) in the corresponding sub-region 710 is static. The free probability 823 indicates a probability that there is no object in the corresponding sub-region 710. The occupied probability 824 indicates a probability that there is an object in (any portion of) the corresponding sub-region 710. Each of the cells 810 may include respective probabilities 821-824 of an object corresponding to the cell 810 being dynamic, static, absent, or present, with a sum of the probabilities being 1. In the example shown in FIG. 8, cells more likely to be free (empty) than occupied are not labeled in the occupancy grid 800 for sake of simplicity of the figure and readability of the occupancy grid 800. Also as shown in FIG. 8, cells more likely to be occupied than free, and occupied by an object that is more likely to be dynamic than static are labeled with a “D”, and cells more likely to be occupied than free, and occupied by an object that is more likely to be static than dynamic are labeled with a “S”. An ego vehicle may not be able to determine whether a cell is occupied or not (e.g., being behind a visible surface of an object and not discernable based on an observed object (e.g., if the size and shape of a detected object is unknown)), and such a cell may be labeled as unknown occupancy.

Building a dynamic occupancy grid (an occupancy grid with a dynamic occupier type) may be helpful, or even essential, for understanding an environment (e.g., the environment 600) of an apparatus to facilitate or even enable further processing. For example, a dynamic occupancy grid may be helpful for predicting occupancy, for motion planning, etc. A dynamic occupancy grid may, at any one time, comprise one or more cells of static occupier type and/or one or more cells of dynamic occupier type. A dynamic object may be represented as a set of one or more velocity vectors. For example, an occupancy grid cell may have some or all of the occupancy probability be dynamic, and within the dynamic occupancy probability, there may be multiple (e.g., four) velocity vectors each with a corresponding probability that together sum to the dynamic occupancy probability for that cell 810. A dynamic occupancy grid may be obtained, e.g., by the occupancy grid unit 560, by processing information from multiple sensors, e.g., of the sensors 540, such as from a radar system. Adding data from one or more cameras to determine the dynamic occupancy grid may provide significant improvements to the grid, e.g., accuracy of probabilities and/or velocities in grid cells.

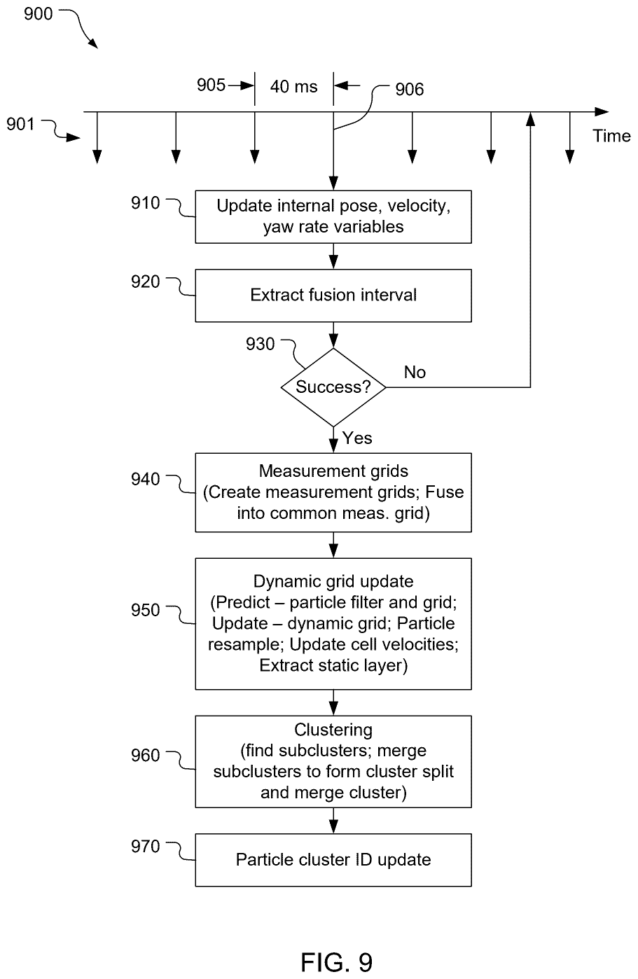

Referring also to FIG. 9, a method 900 of dynamic grid clustering includes the stages shown. The method 900 is, however, an example and not limiting. The method 900 may be altered, e.g., by having one or more stages added, removed, rearranged, combined, performed concurrently, and/or having one or more stages each split into multiple stages. At stage 910, intermittent interrupts 901 (e.g., at a periodic interval 905, e.g., every 40 ms in this example) occurs and a check is made by the processor 510 to determine whether sensor data are available (e.g., vehicle localization information such as speed). In this example, a check is made corresponding to an intermittent interrupt 906. If sensor data are available, then internal pose, velocity, and yaw rate variables are updated based on the sensor data. At stage 920, an extract fusion interval function is performed where sensor data are collected over time. At stage 930, the processor 510 determines whether one or more rules are met corresponding to success, such as at least a threshold number of radar measurements having been made over a specified time interval. If there is success (the rule(s) have been met), then the method 900 proceeds to stage 940, and otherwise returns to checking for data for updating at stage 910. At stage 940, a measurement grid is determined for each sensor for which sensor data are available. Values for grid points for each sensor (e.g., radar, camera, etc.) may be determined. For example, an M×N array (e.g., a 512×512 array) for each sensor may be determined and the arrays combined into a single M×N array of grid points. At stage 950, a dynamic grid update is performed. The processor 510 may determine a predicted grid (e.g., using a particle filter), and may fuse the measurement grid from stage 940 with the predicted grid. At stage 960, a clustering function is performed, e.g., with the processor 510 determining and grouping grid cells with similar velocities and positions (i.e., cells close to each other with similar velocities). At stage 970, a particle cluster ID update function is performed to track the cluster ID (from stage 960) within the particle.

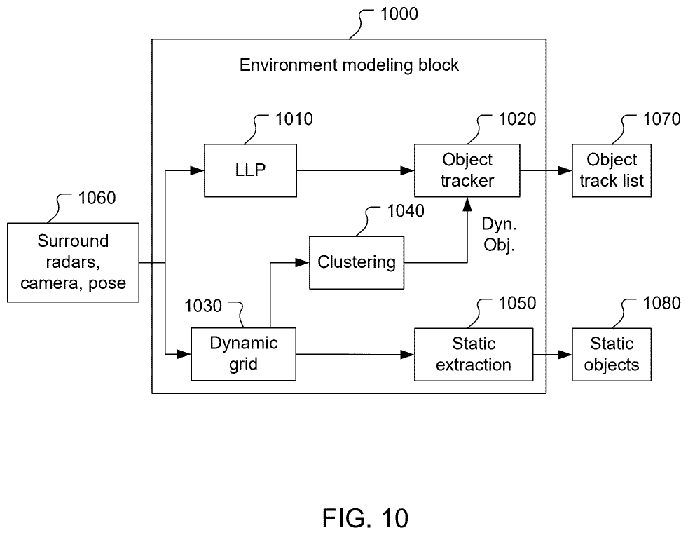

Referring also to FIG. 10, a functional architecture of an environment modeling block 1000 of the device 500 includes functional blocks including an LLP 1010 (Low-Level Perception functional block), an object tracker functional block 1020, a dynamic grid functional block 1030, a clustering functional block 1040, and a static extraction functional block 1050. The LLP 1010 and the dynamic grid functional block 1030 may receive input data 1060 from the radar(s) 542 of the sensors 540, the camera(s) 544 of the sensors 540, and a pose of the device 500 (e.g., an orientation (e.g., yaw) of an ego vehicle relative to a reference axis). The LLP 1010 may be configured to apply machine learning to at least some of the input data 1060 to identify dynamic objects (e.g., vehicles) corresponding to the environment of the device 500, e.g., the environment 600, and output indications of identified objects to the object tracker 1020. The dynamic grid functional block 1030 may be configured to use at least some of the input data 1060 to determine a dynamic grid, e.g., including occupancy probabilities, static/dynamic probabilities, and velocities. The dynamic grid determined by the dynamic grid functional block 1030 may be smaller than a dynamic grid determined by the LLP 1010. The dynamic grid functional block 1030 may use more traditional (non-machine-learning) techniques, which may identify some objects that the LLP 1010 does not identify (e.g., objects with odd shapes and/or disposed at odd angles relative to the device 500). The dynamic grid functional block 1030 may provide the dynamic grid to the clustering functional block 1040 and to the static extraction functional block 1050. The clustering functional block 1040 may be configured to identify clusters of dynamic grid cells with similar properties, e.g., similar object classifications and/or similar velocities, and provide indications of clusters of grid cells of dynamic objects to the object tracker 1020. The object tracker 1020 may be configured to use the indications of identified objects from the LLP 1010 and indications of clusters of dynamic grid cells from the clustering functional block 1040 to track objects, e.g., using a Kalman Filter (or other algorithm). The object tracker 1020 may be configured to fuse the identified objects from the LLP 1010 with dynamic objects (corresponding to cell clusters) determined by the clustering functional block 1040, and output an object track list 1070 indicating tracked objects. The object track list 1070 may include a location, velocity, length, and width (and possibly other information) for each object in the object track list 1070. The object track list 1070 may include a shape to represent each object, e.g., a closed polygon or other shape (e.g., an oval (e.g., indicated by values for the major and minor axes)), with different objects being represented by the same shape or different shapes. The static extraction functional block 1050 may be configured to determine static objects (e.g., road boundaries, traffic signs, etc.) in the dynamic grid provided by the dynamic grid functional block 1030, and provide a static object list 1080 indicating the determined static objects.

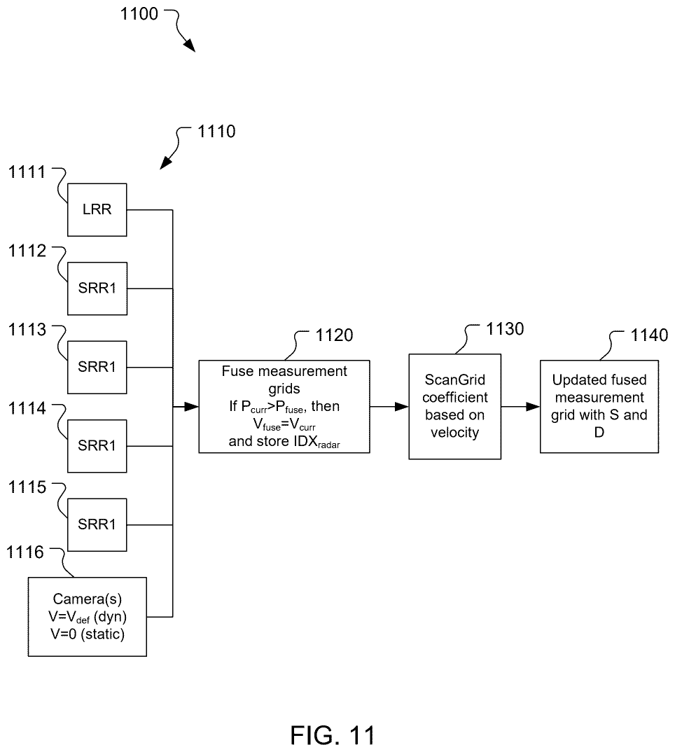

Referring also to FIG. 11, a method 1100 of fusing radar and camera sensor data to determine a measurement grid includes the stages shown. The method 1100 is, however, an example and not limiting. The method 1100 may be altered, e.g., by having one or more stages added, removed, rearranged, combined, performed concurrently, and/or having one or more stages each split into multiple stages.

At stage 1110, radar sensor data and camera sensor data may be obtained. For example, radar sensor data may be obtained from an LRR 1111 (e.g., the LRR sensor 123) and from SRRs 1112, 1113, 1114, 1115 (e.g., the radar sensors 121, 122) (e.g., of the radar(s) 542), and camera sensor data may be obtained from one or more cameras 1116 (e.g., one or more of the cameras 124) (e.g., of the camera(s) 544). The camera(s) 1116 (and/or the processor 510) may be configured to determine a class for each object seen by the camera(s) 1116. Examples of classes may include vehicles (e.g., cars, trucks, buses, motorcycles, UAVs (Unoccupied Aerial Vehicles), etc.), road boundaries, road signs, dynamic objects (e.g., objects that are configured to move), static objects (e.g., objects that are unlikely to move and/or likely to remain stationary), etc. For example, an automobile, even if presently stationary (e.g., as determined from data from one or more radar sensors), may be classified as a vehicle and/or a dynamic object. Other functions (e.g., a particle filter of the dynamic grid update stage 950) may determine that a dynamic object is presently static. The camera(s) 1116 and/or the processor 510 may set a velocity for (each occupancy grid cell for) each object identified and classified by the camera(s) 1116 based on the classification. For example, a velocity may be set to a default, non-zero velocity (e.g., a maximum velocity value) for (each occupancy grid cell for) an object classified as a vehicle or classified as a dynamic object. As another example, a velocity may be set to zero (0) for an object classified as a static object. The sensor data obtained from the radar sensors 1111-1115 and the camera(s) 1116 may comprise sensor measurement grids, with a sensor measurement grid corresponding to each of the sensors 1111-1116. Alternatively, the sensor measurement grids may be determined at stage 1120 from raw sensor data provided by the sensors 1111-1116 at stage 1110. Each of the sensor measurement grids may comprise an occupancy grid including an occupancy probability and corresponding velocity (ies) for each cell of the sensor measurement grid.

At stage 1120, the processor 510, e.g., the occupancy grid unit 560, may fuse the sensor measurement grids to form a fused measurement grid. For example, the processor 510, e.g., the occupancy grid unit 560, may be configured to fuse the sensor measurement grids according to one or more rules. Fusing the sensor measurement grids may comprise considering corresponding cells (e.g., analyzing data of cells corresponding to the same sub-region, but from all the different sensor measurement grids, to determine a single fused measurement grid). For example, the occupancy grid unit 560 may be configured to assess, initially, the occupancy probabilities for corresponding cells (e.g., cells corresponding to the same geographic area) of two different sensor measurement grids, using one of the sensor measurement grids as a reference measurement grid and the other sensor measurement grid as a current measurement grid. The occupancy grid unit 560 may be configured to determine which occupancy probability is higher, and use the velocity of the cell with the higher occupancy probability as the velocity for a corresponding cell of the fused measurement grid. The occupancy grid unit 560 may be configured to store, for the corresponding cell of the fused measurement grid, an indication of (e.g., an index of) the sensor corresponding to the current measurement grid if the velocity of the current measurement grid is used as the velocity of the fused measurement grid. The occupancy grid unit 560 may be configured to determine an occupancy probability for the cell of the fused measurement grid as a combination (e.g., average) of the occupancy probabilities of the two assessed occupancy probabilities. The occupancy probabilities may, for example be combined only if the occupancy probability of the cell of the current measurement grid is higher than the occupancy probability of the cell of the reference measurement grid. The combination of occupancy probabilities may be a weighted average, giving more weight (e.g., 0.6 vs. 0.4) to the higher occupancy probability. The occupancy grid unit 560 may be configured to determine the velocity and occupancy probability for all corresponding cells of the reference measurement grid and the current measurement grid. The occupancy grid unit 560 may be configured to repeat this process, but assessing the occupancy probabilities of cells of the fused measurement grid (as the reference measurement grid) with the occupancy probabilities of cells of another one of the sensor measurement grids (as the current measurement grid), and repeat this process until all of the sensor measurement grids have been assessed.

The occupancy grid unit 560 may fuse the reference grid and the current grid (e.g., two measurement grids, or the fused grid and a measurement grid) according to one or more rules. For example, the occupancy grid unit 560 may assess the measurement grids in a specific order, e.g., sequentially according to a sensor index number (e.g., in ascending order of index number). The order may, however, be determined in another way. As another example, the occupancy grid unit 560 may give a higher priority to one or more of the sensors relative to one or more other sensors. For example, fusing may be withheld until a grid from a higher-priority sensor is available (e.g., do not fuse unless a camera grid is available). As another example, the occupancy grid unit 560 may wait up to a threshold time period for new sensor data to be available for all of the sensors 1111-1116 before fusing, but may not wait beyond the threshold (e.g., a specified) time period even if new sensor data are not available for all the sensors 1111-1116. As another example, a fusion interval (also called a frame), e.g., the interval 905, between instances of assessing whether sensor data are available for measurement grid determination and fusing may be a function of velocity (or simply speed) of the ego vehicle and/or a present environment scenario (e.g., a probability of a collision occurring and/or how soon a collision may occur), etc. As another example, camera data may not be used to determine the fused measurement grid (e.g., not used to determine a measurement grid or, if determined, not used as a current measurement grid for fusing with the fused measurement grid) if the camera sensor data are not available (e.g., not available at every fusion interval (frame)) and/or FRR (Front-facing Ranging Radar) sensor data are not available.

At stage 1130, the processor 510, e.g., the occupancy grid unit 560, may determine coefficients indicative of how much occupied mass of a cell is static and how much of the occupied mass of a cell is dynamic. The occupancy grid unit 560 may be configured to determine two coefficients for each cell based on the velocity of the respective cell, e.g., with a higher velocity resulting in a higher coefficient value and a lower velocity (e.g., 0 m/s) resulting in a lower (e.g., low, such as 0) coefficient value. For example, with m(O) being the occupied mass (a value between 0 and 1, inclusive, i.e., m(O) ϵ[0, 1], β_{S} being the static coefficient, and β_{D} being the dynamic coefficient, the static and dynamic masses, and a new occupied mass, may be determined according to

$$m ( S ) = {β}_{S} m ( O ) \qquad ( 1 )$$

$$m ( D ) = {β}_{D} m ( O ) \qquad ( 2 )$$

$$m {( O )}_{new} = ( 1 - {β}_{S} - {β}_{D} ) m ( O ) \qquad ( 3 )$$

where m(S) is the static mass (also referred to as S) and m(D) is the dynamic mass (also referred to as D). Provided a longitudinal velocity and a lateral velocity for a cell, a non-zero absolute velocity may be determined for the cell. The dynamic coefficient BD may be determined such that the dynamic coefficient is a non-decreasing (either flat or increasing) function of absolute velocity and the static coefficient Bs may be determined such that the static coefficient is a non-increasing function of absolute velocity.

At stage 1140, the processor 510, e.g., the occupancy grid unit 560, may determine, based on the fused measurement grid determined at stage 1120 and the coefficients determined at stage 1130, an updated fused measurement grid including static and dynamic probabilities. The updated measurement grid may have, for each cell, an occupied probability, a free (empty) probability, a static probability, and a dynamic probability. The updated measurement grid may have the four probabilities for each cell that is not occluded, and may have an occluded status otherwise (if the cell is not visible by the ego vehicle, e.g., being obscured by another object (e.g., cells in a field of view of the vehicle 601 but obscured by the vehicle 602)). The occupancy grid unit 560 may determine the static probability and/or the dynamic probability of a cell by considering an occupancy probability and/or a velocity for the cell from the fused measurement grid from stage 1120, and one or more of the coefficients from stage 1130. For example, if an occupancy probability from stage 1120 is 0.8, a velocity is 10 m/s, and a dynamic coefficient is 0.85, then the occupancy grid unit 560 may set the dynamic probability for that cell of the updated fused measurement grid to be, for example, 0.9 due to the occupied probability being high, the dynamic mass being high, and the velocity being high. For a presently-stationary dynamic object, the dynamic coefficient will be low, but the dynamic probability will be high, and the present static status may be determined outside of stage 1140 (e.g., by a particle filter at stage 950).

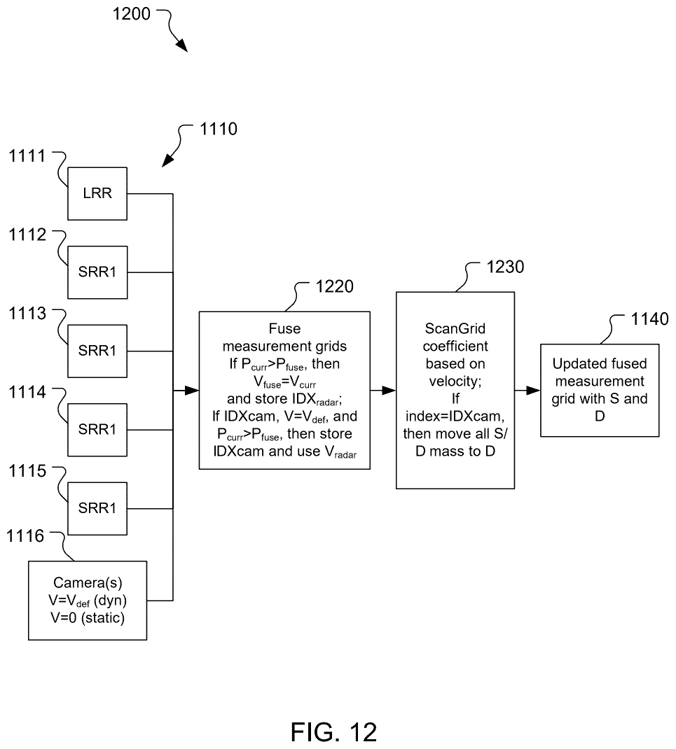

Referring also to FIG. 12, another method 1200 of fusing radar and camera sensor data to determine a measurement grid includes the stages shown. The method 1200 is, however, an example and not limiting. The method 1200 may be altered, e.g., by having one or more stages added, removed, rearranged, combined, performed concurrently, and/or having one or more stages each split into multiple stages. The method 1200 includes the stage 1110 and the stage 1140 from the method 1100 discussed above.

At stage 1220, the processor 510, e.g., the occupancy grid unit 560, may fuse the sensor measurement grids to form a fused measurement grid as discussed above with respect to the stage 1120, but with the addition of another rule. At stage 1220, if the sensor index for a measurement grid cell for a current measurement grid is a camera index, the velocity is the default velocity (e.g., a velocity (e.g., a maximum velocity) that is indicative of camera sensor data being indicative of a dynamic object), and an occupancy probability (P_{curr}) of the cell in the current measurement grid being greater than an occupancy probability (P_{fuse}) of the reference measurement grid (e.g., the fused measurement grid after the first two measurement grids are assessed), then the index for the cell is set to the camera index (IDXcam) and the velocity based on radar sensor data is used (here, the velocity of the fused measurement grid for the presently-assessed cell is left unaltered). For each cell of the fused measurement grid, the occupancy grid unit 560 may store an occupancy probability, velocity, and sensor index of the sensor that was used to determine the velocity that is stored for that cell. The occupancy grid unit 560 may also store an indication that a cell is occupied by a vehicle, or use the sensor index being the camera index as such an indication. At stage 1230, in addition to the operations discussed above with respect to stage 1130, the occupancy grid unit 560 may set all of the static/dynamic mass of a cell to dynamic based on the sensor index for the cell being the camera index (IDXcam).

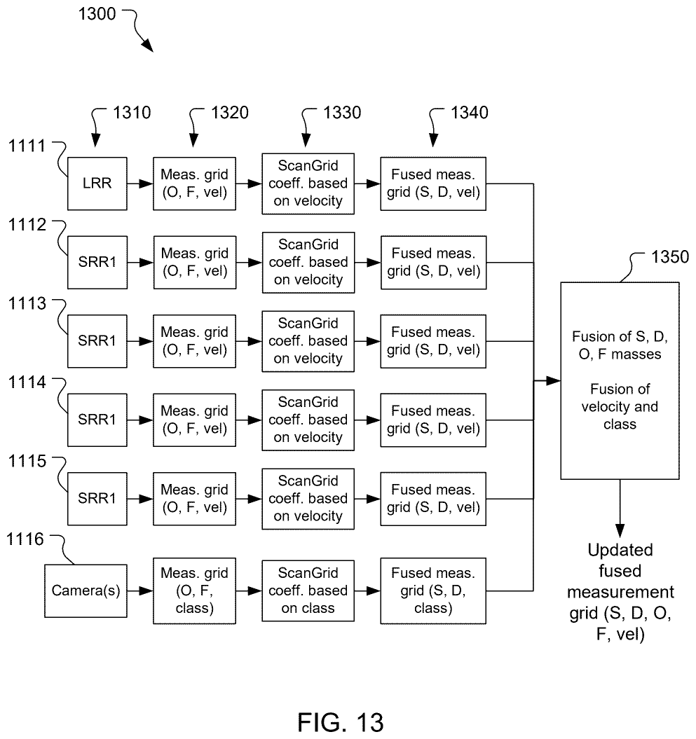

Referring also to FIG. 13, another method 1300 of fusing radar and camera sensor data to determine a measurement grid includes the stages shown. The method 1300 is, however, an example and not limiting. The method 1300 may be altered, e.g., by having one or more stages added, removed, rearranged, combined, performed concurrently, and/or having one or more stages each split into multiple stages. At stage 1310, the sensors 1111-1116 may provide sensor data to the processor 510. At stage 1320, the processor 510, e.g., the occupancy grid unit 560, may determine a measurement grid corresponding to each of the sensors 1111-1116. For each of the sensors 1111-1115, the respective measurement grid contains, for each cell, an occupancy probability (O), a free probability (F), and a velocity. For each of the camera(s) 1116, the respective measurement grid contains, for each cell, an occupancy probability (O), a free probability (F), and a class of object. A class may always be provided, or may be conditionally provided (e.g., only if the occupancy probability is non-zero, or only if the occupancy probability exceeds a threshold value, e.g., 0.5). At stage 1330, for each of the sensors 1111-1115 the processor 510, e.g., the occupancy grid unit 560, may determine scan grid coefficients for each cell based on a velocity of that cell. At stage 1330, for the sensor 1116, the occupancy grid unit 560 may determine scan grid coefficients for each cell based on the object class for that cell, e.g., with the static scan grid coefficient being set to zero, and the dynamic scan grid coefficient being set to one (1), if the class is indicative of a dynamic object. At stage 1340, the processor 510, e.g., the occupancy grid unit 560, may determine static mass(S) and dynamic mass (D) of the occupied mass of each cell. For example, the static and dynamic coefficients β_{S}, β_{D} of each cell may be determined from non-increasing and non-decreasing functions of absolute velocity, and the static mass(S) and dynamic mass (D) may be determined using Equations (1) and (2), respectively. For each of the fused measurement grids corresponding to the sensors 1111-1115, the velocity of each cell is determined from (e.g., set to) the velocity of the closest cell with a velocity that is based on radar detection (the velocity from stage 1320). For the fused measurement grid corresponding to the sensor 1116, the class of each cell is the class of the respective cell determined at stage 1320. The fused measurement grids determined at stage 1340 may be fused at stage 1350.

At stage 1350, the occupancy grid unit 560 may fuse static, dynamic, occupied, and free masses of respective cells of the measurement grids determined at stage 1340 and may fuse velocities and classes of respective cells of the measurement grids determined at stage 1340. For example, the occupancy grid unit 560 may apply a combination rule in accordance with the Dempster-Shafer theory (or the Bayesian theory) to the static mass values of corresponding cells of the grids determined at stage 1340 to determine the static mass (probability) values of the cells of an updated fused measurement grid. The occupancy grid unit 560 may do the same for the dynamic mass values, the occupied mass values, and the free mass values, respectively, to determine the dynamic mass values, the occupied mass values, and the free mass values for the cells of the updated fused measurement grid. The occupancy grid unit 560 may determine fused velocities of corresponding cells of the grids determined at stage 1340 by soft weighting based on occupied masses (or dynamic masses and/or static masses) of each set of corresponding cells (i.e., a corresponding cell from one or more of the fused grids forming a set of corresponding cells) to determine the velocities of the cells of an updated fused measurement grid. Class and velocity values may be fused to determine the velocity value of each updated measurement grid cell. Velocity values may be assigned to the class values of the cells of the grid(s) determined at stage 1340 corresponding to the camera(s) 1116 (e.g., zero for a class of object that is stationary and a non-zero default value for any class of object that is non-stationary). The camera class may be used to assign a zero velocity even if radar-based velocity is non-zero. Alternatively, if the class is a dynamic object (e.g., a vehicle), then even if the occupancy mass of a cell based on camera measurement is higher than the occupancy mass of that cell based on radar measurement, the radar-based velocity value may be used as the velocity in the updated measurement grid for that cell. At stage 1350, the occupancy grid unit 560 outputs an updated fused measurement grid containing S, D, O, F, and velocity values for each cell.

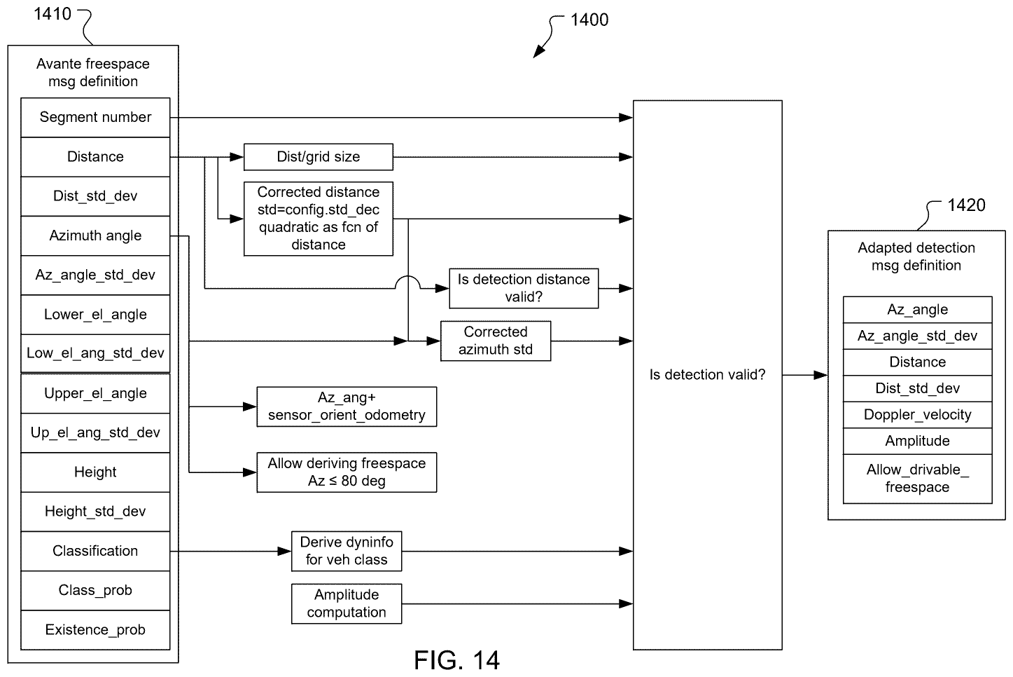

Referring to FIG. 14, with further reference to FIG. 5, a message flow 1400 shows message information for a camera of the device 500. A subset of available camera data 1410 is used to determine adapted detection information 1420. At least some of the adapted detection information 1420 (e.g., distance, standard deviation of distance, angle, and standard deviation of angle of an object relative to the device 500) may be used by the occupancy grid unit 560 to determine occupancy grids. For example, object measurements may be used to determine cells between the device 500 and a detected object (e.g., a nearest detected object of a given angle) that are free (unoccupied).

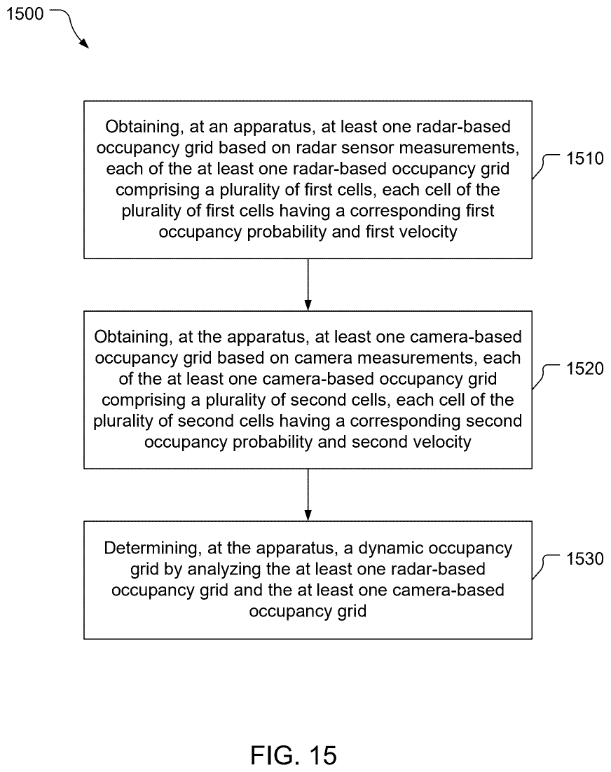

Referring to FIG. 15, with further reference to FIGS. 1-14, a dynamic occupancy grid determination method 1500 includes the stages shown. The method 1500 is, however, an example and not limiting. The method 1500 may be altered, e.g., by having one or more stages added, removed, rearranged, combined, performed concurrently, and/or having one or more stages each split into multiple stages.

At stage 1510, the method 1500 includes obtaining, at an apparatus, at least one radar-based occupancy grid based on radar sensor measurements, each of the at least one radar-based occupancy grid comprising a plurality of first cells, each cell of the plurality of first cells having a corresponding first occupancy probability and first velocity. For example, the occupancy grid unit 560 may receive (e.g., via the transceiver 520) one or more radar-based occupancy grids and/or determine an occupancy grid from sensor data from each of the sensors 1111-1115. The processor 510, possibly in combination with the memory 530, possibly in combination with the transceiver 520 (e.g., the wireless receiver 244 and the antenna 246) may comprise means for obtaining at least one radar-based occupancy grid based on radar sensor measurements.

At stage 1520, the method 1500 includes obtaining, at the apparatus, at least one camera-based occupancy grid based on camera measurements, each of the at least one camera-based occupancy grid comprising a plurality of second cells, each cell of the plurality of second cells having a corresponding second occupancy probability and second velocity. For example, the occupancy grid unit 560 may receive (e.g., via the transceiver 520) one or more camera-based occupancy grids and/or determine an occupancy grid from sensor data from each of the camera(s) 1116. The processor 510, possibly in combination with the memory 530, possibly in combination with the transceiver 520 (e.g., the wireless receiver 244 and the antenna 246), possibly in combination with the camera(s) 1116 may comprise means for obtaining at least one camera-based occupancy grid based on camera measurements.

At stage 1530, the method 1500 includes determining, at the apparatus, a dynamic occupancy grid by analyzing the at least one radar-based occupancy grid and the at least one camera-based occupancy grid. For example, the occupancy grid unit 560 may fuse occupancy grids at stage 1120, stage 1220, or stage 1340 discussed above, or determine an updated fused measurement grid at stage 1140, or stage 1350 discussed above. The processor 510, possibly in combination with the memory 530, may comprise means for determining the dynamic occupancy grid.

Implementations of the method 1500 may include one or more of the following features. In an example implementation, determining the dynamic occupancy grid comprises: setting the second velocity to a non-zero default velocity for each of the plurality of second cells occupied by an object classified as a vehicle; and setting the second velocity to zero for each of the plurality of second cells that is either unoccupied or occupied by an object classified as a static object. For example, at stage 1110, the occupancy grid unit 560 may be configured to set a velocity of an occupancy grid cell corresponding to a dynamic object, as identified by a camera, to a non-zero default value and configured to set a velocity of an occupancy grid cell corresponding to a static object, as identified by a camera, to zero. The processor 510, possibly in combination with the memory 530, may comprise means for setting the second velocity to a non-zero default velocity and means for setting the second velocity to zero. In another example implementation, the method 1500 includes determining the at least one radar-based occupancy grid and the at least one camera-based occupancy grid. For example, instead of or in addition to receiving one or more radar-based occupancy grids and one or more camera-based occupancy grids, the occupancy grid unit 560 may determine the grids. The processor 510, possibly in combination with the memory 530, may comprise means for determining the at least one radar-based occupancy grid and the at least one camera-based occupancy grid. In a further example implementation, the method 1500 includes waiting for sensor data from all of a plurality of radar sensors of the apparatus and all of at least one camera of the apparatus, or expiration of a sensor data collection time interval, before determining the at least one radar-based occupancy grid and the at least one camera-based occupancy grid. For example, the occupancy grid unit 560 may wait for the interval 905 to finish, or until new sensor data are available from all the sensors 1111-1116 if earlier than the finish of the interval 905, to being determining the occupancy grids. The processor 510, possibly in combination with the memory 530, may comprise means for waiting. In a further example implementation, the method 1500 includes determining the sensor data collection time interval as a function of speed of the apparatus. For example, the occupancy grid unit 560 may determine the duration of the interval 905 based on a speed of the device 500 (e.g., with the interval 905 being shorter the higher the speed of the device 500 is). The processor 510, possibly in combination with the memory 530, in combination with one or more of the sensors (e.g., a speedometer and/or an IMU) may comprise means for determining the sensor data collection time interval.

Also or alternatively, implementations of the method 1500 may include one or more of the following features. In an example implementation, the method 1500 includes fusing, at the apparatus, the at least one radar-based occupancy grid and the at least one camera-based occupancy grid to determine a fused occupancy grid. For example, the occupancy grid unit 560 may fuse occupancy grids at stage 1120 or stage 1220. The processor 510, possibly in combination with the memory 530, may comprise means for fusing the at least one radar-based occupancy grid and the at least one camera-based occupancy grid. In a further example implementation, the at least one radar-based occupancy grid and the at least one camera-based occupancy grid are fused only if most-recent available camera sensor data and most-recent available radar sensor data correspond to a same sensor data collection time interval. For example, the occupancy grid unit 560 may not fuse occupancy grids if camera sensor data are not available (e.g., at all, or every data collection interval). As another example, the occupancy grid unit 560 may not fuse occupancy grids if either camera sensor data or FRR data are not available (e.g., at all, or every data collection interval). In another further example implementation, fusing the at least one radar-based occupancy grid and the at least one camera-based occupancy grid comprises using, for a fused occupancy grid cell, a reference velocity of a reference occupancy grid cell, corresponding to the fused occupancy grid cell, based on: a camera-based occupancy probability of a camera-based occupancy grid cell, corresponding to the reference occupancy grid cell, being greater than a reference occupancy probability of the reference occupancy grid cell; and an indication that the camera-based occupancy grid cell is occupied by a vehicle. For example, at stage 1220, the occupancy grid unit 560 may use a velocity of an occupancy grid or a velocity of the fused occupancy grid (if at least one fusion has already been performed) as the velocity of the fused occupancy grid if a current occupancy grid being fused with the reference occupancy grid is a camera-based occupancy grid, the occupancy probability of a cell under evaluation of the camera-based occupancy grid is greater than the occupancy probability of the corresponding cell of the reference occupancy grid, and the sensor index of the current occupancy grid is an index of a camera and/or a velocity of the current occupancy grid cell is a velocity associated with a vehicle (e.g., a maximum velocity). In another further example implementation, the method includes setting, at the apparatus, a dynamic probability of a fused occupancy grid cell of the fused occupancy grid to a non-zero value and a static probability of the fused occupancy grid cell of the fused occupancy grid to zero based on an indication that a camera-based occupancy probability corresponding to the fused occupancy grid cell was higher than a radar-based occupancy probability corresponding to the fused occupancy grid cell. For example, at stage 1230, the occupancy grid unit 560 may set a static/dynamic mass of a particular fused occupancy grid cell to dynamic based on a camera index being associated with (e.g., stored as part of) the particular cell. The processor 510, possibly in combination with the memory 530, may comprise means for setting the dynamic probability and the static probability. In another further example implementation, fusing the at least one radar-based occupancy grid and the at least one camera-based occupancy grid includes: determining, at the apparatus, at least one radar-based fused measurement grid each corresponding to a respective one of the at least one radar-based occupancy grid by fusing the respective one of the at least one radar-based occupancy grid and first occupancy coefficients; determining, at the apparatus, at least one camera-based fused measurement grid each corresponding to a respective one of the at least one camera-based occupancy grid by fusing the respective one of the at least one camera-based occupancy grid and second occupancy coefficients; and fusing, at the apparatus, the at least one radar-based fused measurement grid and the at least one camera-based fused measurement grid to determine an updated fused measurement grid. For example, fused measurement grids may be determined at stage 1340 based on coefficients determined at stage 1330, and the fused measurement grids determined at stage 1340 fused at stage 1350 to determine an updated fused measurement grid. In a further example implementation, fusing the at least one radar-based fused measurement grid and the at least one camera-based fused measurement grid comprises applying the Dempster-Shafer theory. For example, the Dempster-Shafer theory may be applied at stage 1350 to fuse static, dynamic, occupied, and free masses, respectively, of the fused measurement grids from stage 1340 to determine the updated fused measurement grid. In another further example implementation, fusing the at least one radar-based fused measurement grid and the at least one camera-based fused measurement grid comprises soft weighting respective velocities of the at least one radar-based fused measurement grid and the at least one camera-based fused measurement grid. In another further example implementation, fusing the at least one radar-based fused measurement grid and the at least one camera-based fused measurement grid comprises setting a velocity of a cell of the updated fused measurement grid to zero based on a camera-based classification of the cell being other than a dynamic object. In another further example implementation, fusing the at least one radar-based fused measurement grid and the at least one camera-based fused measurement grid comprises setting a velocity of a cell of the updated fused measurement grid to a radar-based velocity based on at least one velocity of the at least one radar-based fused measurement grid based on a camera-based classification of the cell being indicative of a dynamic object. For example, if a particular cell has a camera-based classification of dynamic, then the velocity for that cell of the updated fused measurement grid may be set to a radar-based velocity for that cell from one or more of the fused measurement grids from stage 1340.

### Implementation Examples

Implementation examples are provided in the following numbered clauses.

Clause 1. An apparatus comprising:
at least one memory; and
at least one processor communicatively coupled to the at least one memory and configured to:
   obtain at least one radar-based occupancy grid based on radar sensor measurements, each of the at least one radar-based occupancy grid comprising a plurality of first cells, each cell of the plurality of first cells having a corresponding first occupancy probability and first velocity;
   obtain at least one camera-based occupancy grid based on camera measurements, each of the at least one camera-based occupancy grid comprising a plurality of second cells, each cell of the plurality of second cells having a corresponding second occupancy probability and second velocity; and
   determine a dynamic occupancy grid by analyzing the at least one radar-based occupancy grid and the at least one camera-based occupancy grid.

Clause 2. The apparatus of clause 1, wherein to determine the dynamic occupancy grid the at least one processor is configured to:
set the second velocity to a non-zero default velocity for each of the plurality of second cells occupied by an object classified as a vehicle; and
set the second velocity to zero for each of the plurality of second cells that is either unoccupied or occupied by an object classified as a static object.

Clause 3. The apparatus of clause 1, wherein the at least one processor is configured to determine the at least one radar-based occupancy grid and the at least one camera-based occupancy grid.

Clause 4. The apparatus of clause 3, wherein the at least one processor is configured to wait for sensor data from all of a plurality of radar sensors of the apparatus and all of at least one camera of the apparatus, or expiration of a sensor data collection time interval, before determining the at least one radar-based occupancy grid and the at least one camera-based occupancy grid.

Clause 5. The apparatus of clause 4, wherein the at least one processor is configured to determine the sensor data collection time interval as a function of speed of the apparatus.

Clause 6. The apparatus of clause 1, wherein the at least one processor is configured to fuse the at least one radar-based occupancy grid and the at least one camera-based occupancy grid to determine a fused occupancy grid.

Clause 7. The apparatus of clause 6, wherein the at least one processor is configured to fuse the at least one radar-based occupancy grid and the at least one camera-based occupancy grid only if most-recent available camera sensor data and most-recent available radar sensor data correspond to a same sensor data collection time interval.

Clause 8. The apparatus of clause 6, wherein to fuse the at least one radar-based occupancy grid and the at least one camera-based occupancy grid, the at least one processor is configured to use, for a fused occupancy grid cell, a reference velocity of a reference occupancy grid cell, corresponding to the fused occupancy grid cell, based on: a camera-based occupancy probability of a camera-based occupancy grid cell, corresponding to the reference occupancy grid cell, being greater than a reference occupancy probability of the reference occupancy grid cell; and an indication that the camera-based occupancy grid cell is occupied by a vehicle.

Clause 9. The apparatus of clause 6, wherein the at least one processor is configured to set a dynamic probability of a fused occupancy grid cell of the fused occupancy grid to a non-zero value and a static probability of the fused occupancy grid cell of the fused occupancy grid to zero based on an indication that a camera-based occupancy probability corresponding to the fused occupancy grid cell was higher than a radar-based occupancy probability corresponding to the fused occupancy grid cell.

Clause 10. The apparatus of clause 6, wherein to fuse the at least one radar-based occupancy grid and the at least one camera-based occupancy grid the at least one processor is configured to:
determine at least one radar-based fused measurement grid each corresponding to a respective one of the at least one radar-based occupancy grid by fusing the respective one of the at least one radar-based occupancy grid and first occupancy coefficients;
determine at least one camera-based fused measurement grid each corresponding to a respective one of the at least one camera-based occupancy grid by fusing the respective one of the at least one camera-based occupancy grid and second occupancy coefficients; and
fuse the at least one radar-based fused measurement grid and the at least one camera-based fused measurement grid to determine an updated fused measurement grid.

Clause 11. The apparatus of clause 10, wherein to fuse the at least one radar-based fused measurement grid and the at least one camera-based fused measurement grid the at least one processor is configured to apply the Dempster-Shafer theory.

Clause 12. The apparatus of clause 10, wherein to fuse the at least one radar-based fused measurement grid and the at least one camera-based fused measurement grid the at least one processor is configured to soft weight respective velocities of the at least one radar-based fused measurement grid and the at least one camera-based fused measurement grid.

Clause 13. The apparatus of clause 10, wherein to fuse the at least one radar-based fused measurement grid and the at least one camera-based fused measurement grid the at least one processor is configured to set a velocity of a cell of the updated fused measurement grid to zero based on a camera-based classification of the cell being other than a dynamic object.

Clause 14. The apparatus of clause 10, wherein to fuse the at least one radar-based fused measurement grid and the at least one camera-based fused measurement grid the at least one processor is configured to set a velocity of a cell of the updated fused measurement grid to a radar-based velocity based on at least one velocity of the at least one radar-based fused measurement grid based on a camera-based classification of the cell being indicative of a dynamic object.

Clause 15. A dynamic occupancy grid determination method comprising:
obtaining, at an apparatus, at least one radar-based occupancy grid based on radar sensor measurements, each of the at least one radar-based occupancy grid comprising a plurality of first cells, each cell of the plurality of first cells having a corresponding first occupancy probability and first velocity;
obtaining, at the apparatus, at least one camera-based occupancy grid based on camera measurements, each of the at least one camera-based occupancy grid comprising a plurality of second cells, each cell of the plurality of second cells having a corresponding second occupancy probability and second velocity; and
determining, at the apparatus, a dynamic occupancy grid by analyzing the at least one radar-based occupancy grid and the at least one camera-based occupancy grid.

Clause 16. The dynamic occupancy grid determination method of clause 15, wherein determining the dynamic occupancy grid comprises:
setting the second velocity to a non-zero default velocity for each of the plurality of second cells occupied by an object classified as a vehicle; and
setting the second velocity to zero for each of the plurality of second cells that is either unoccupied or occupied by an object classified as a static object.

Clause 17. The dynamic occupancy grid determination method of clause 15, further comprising determining the at least one radar-based occupancy grid and the at least one camera-based occupancy grid.

Clause 18. The dynamic occupancy grid determination method of clause 17, further comprising waiting for sensor data from all of a plurality of radar sensors of the apparatus and all of at least one camera of the apparatus, or expiration of a sensor data collection time interval, before determining the at least one radar-based occupancy grid and the at least one camera-based occupancy grid.

Clause 19. The dynamic occupancy grid determination method of clause 18, further comprising determining the sensor data collection time interval as a function of speed of the apparatus.

Clause 20. The dynamic occupancy grid determination method of clause 15, further comprising fusing, at the apparatus, the at least one radar-based occupancy grid and the at least one camera-based occupancy grid to determine a fused occupancy grid.

Clause 21. The dynamic occupancy grid determination method of clause 20, wherein the at least one radar-based occupancy grid and the at least one camera-based occupancy grid are fused only if most-recent available camera sensor data and most-recent available radar sensor data correspond to a same sensor data collection time interval.

Clause 22. The dynamic occupancy grid determination method of clause 20, wherein fusing the at least one radar-based occupancy grid and the at least one camera-based occupancy grid comprises using, for a fused occupancy grid cell, a reference velocity of a reference occupancy grid cell, corresponding to the fused occupancy grid cell, based on:
a camera-based occupancy probability of a camera-based occupancy grid cell, corresponding to the reference occupancy grid cell, being greater than a reference occupancy probability of the reference occupancy grid cell; and
an indication that the camera-based occupancy grid cell is occupied by a vehicle.

Clause 23. The dynamic occupancy grid determination method of clause 20, further comprising setting, at the apparatus, a dynamic probability of a fused occupancy grid cell of the fused occupancy grid to a non-zero value and a static probability of the fused occupancy grid cell of the fused occupancy grid to zero based on an indication that a camera-based occupancy probability corresponding to the fused occupancy grid cell was higher than a radar-based occupancy probability corresponding to the fused occupancy grid cell.

Clause 24. The dynamic occupancy grid determination method of clause 20, wherein fusing the at least one radar-based occupancy grid and the at least one camera-based occupancy grid comprises:
determining, at the apparatus, at least one radar-based fused measurement grid each corresponding to a respective one of the at least one radar-based occupancy grid by fusing the respective one of the at least one radar-based occupancy grid and first occupancy coefficients;
determining, at the apparatus, at least one camera-based fused measurement grid each corresponding to a respective one of the at least one camera-based occupancy grid by fusing the respective one of the at least one camera-based occupancy grid and second occupancy coefficients; and
fusing, at the apparatus, the at least one radar-based fused measurement grid and the at least one camera-based fused measurement grid to determine an updated fused measurement grid.

Clause 25. The dynamic occupancy grid determination method of clause 24, wherein fusing the at least one radar-based fused measurement grid and the at least one camera-based fused measurement grid comprises applying the Dempster-Shafer theory.

Clause 26. The dynamic occupancy grid determination method of clause 24, wherein fusing the at least one radar-based fused measurement grid and the at least one camera-based fused measurement grid comprises soft weighting respective velocities of the at least one radar-based fused measurement grid and the at least one camera-based fused measurement grid.

Clause 27. The dynamic occupancy grid determination method of clause 24, wherein fusing the at least one radar-based fused measurement grid and the at least one camera-based fused measurement grid comprises setting a velocity of a cell of the updated fused measurement grid to zero based on a camera-based classification of the cell being other than a dynamic object.

Clause 28. The dynamic occupancy grid determination method of clause 24, wherein fusing the at least one radar-based fused measurement grid and the at least one camera-based fused measurement grid comprises setting a velocity of a cell of the updated fused measurement grid to a radar-based velocity based on at least one velocity of the at least one radar-based fused measurement grid based on a camera-based classification of the cell being indicative of a dynamic object.

Clause 29. An apparatus comprising:
means for obtaining at least one radar-based occupancy grid based on radar sensor measurements, each of the at least one radar-based occupancy grid comprising a plurality of first cells, each cell of the plurality of first cells having a corresponding first occupancy probability and first velocity;
means for obtaining at least one camera-based occupancy grid based on camera measurements, each of the at least one camera-based occupancy grid comprising a plurality of second cells, each cell of the plurality of second cells having a corresponding second occupancy probability and second velocity; and
means for determining a dynamic occupancy grid by analyzing the at least one radar-based occupancy grid and the at least one camera-based occupancy grid.

Clause 30. The apparatus of clause 29, wherein the means for determining the dynamic occupancy grid comprise:
means for setting the second velocity to a non-zero default velocity for each of the plurality of second cells occupied by an object classified as a vehicle; and
means for setting the second velocity to zero for each of the plurality of second cells that is either unoccupied or occupied by an object classified as a static object.

Clause 31. The apparatus of clause 29, further comprising means for determining the at least one radar-based occupancy grid and the at least one camera-based occupancy grid.

Clause 32. The apparatus of clause 31, further comprising means for waiting for sensor data from all of a plurality of radar sensors of the apparatus and all of at least one camera of the apparatus, or expiration of a sensor data collection time interval, before determining the at least one radar-based occupancy grid and the at least one camera-based occupancy grid.

Clause 33. The apparatus of clause 32, further comprising means for determining the sensor data collection time interval as a function of speed of the apparatus.

Clause 34. The apparatus of clause 29, further comprising means for fusing the at least one radar-based occupancy grid and the at least one camera-based occupancy grid to determine a fused occupancy grid.

Clause 35. The apparatus of clause 34, wherein the means for fusing the at least one radar-based occupancy grid and the at least one camera-based occupancy grid are for fusing the at least one radar-based occupancy grid and the at least one camera-based occupancy grid only if most-recent available camera sensor data and most-recent available radar sensor data correspond to a same sensor data collection time interval.

Clause 36. The apparatus of clause 34, wherein the means for fusing the at least one radar-based occupancy grid and the at least one camera-based occupancy grid comprise means for using, for a fused occupancy grid cell, a reference velocity of a reference occupancy grid cell, corresponding to the fused occupancy grid cell, based on:
a camera-based occupancy probability of a camera-based occupancy grid cell, corresponding to the reference occupancy grid cell, being greater than a reference occupancy probability of the reference occupancy grid cell; and
an indication that the camera-based occupancy grid cell is occupied by a vehicle.

Clause 37. The apparatus of clause 34, further comprising means for setting a dynamic probability of a fused occupancy grid cell of the fused occupancy grid to a non-zero value and a static probability of the fused occupancy grid cell of the fused occupancy grid to zero based on an indication that a camera-based occupancy probability corresponding to the fused occupancy grid cell was higher than a radar-based occupancy probability corresponding to the fused occupancy grid cell.

Clause 38. The apparatus of clause 34, wherein the means for fusing the at least one radar-based occupancy grid and the at least one camera-based occupancy grid comprise:
means for determining at least one radar-based fused measurement grid each corresponding to a respective one of the at least one radar-based occupancy grid by fusing the respective one of the at least one radar-based occupancy grid and first occupancy coefficients;
means for determining at least one camera-based fused measurement grid each corresponding to a respective one of the at least one camera-based occupancy grid by fusing the respective one of the at least one camera-based occupancy grid and second occupancy coefficients; and
means for fusing the at least one radar-based fused measurement grid and the at least one camera-based fused measurement grid to determine an updated fused measurement grid.

Clause 39. The apparatus of clause 38, wherein the means for fusing the at least one radar-based fused measurement grid and the at least one camera-based fused measurement grid comprise means for applying the Dempster-Shafer theory.

Clause 40. The apparatus of clause 38, wherein the means for fusing the at least one radar-based fused measurement grid and the at least one camera-based fused measurement grid comprise means for soft weighting respective velocities of the at least one radar-based fused measurement grid and the at least one camera-based fused measurement grid.

Clause 41. The apparatus of clause 38, wherein the means for fusing the at least one radar-based fused measurement grid and the at least one camera-based fused measurement grid comprise means for setting a velocity of a cell of the updated fused measurement grid to zero based on a camera-based classification of the cell being other than a dynamic object.

Clause 42. The apparatus of clause 38, wherein the means for fusing the at least one radar-based fused measurement grid and the at least one camera-based fused measurement grid comprise means for setting a velocity of a cell of the updated fused measurement grid to a radar-based velocity based on at least one velocity of the at least one radar-based fused measurement grid based on a camera-based classification of the cell being indicative of a dynamic object.

Clause 43. A non-transitory, processor-readable storage medium comprising processor-readable instructions to cause a processor of an apparatus to:
obtain at least one radar-based occupancy grid based on radar sensor measurements, each of the at least one radar-based occupancy grid comprising a plurality of first cells, each cell of the plurality of first cells having a corresponding first occupancy probability and first velocity;
obtain at least one camera-based occupancy grid based on camera measurements, each of the at least one camera-based occupancy grid comprising a plurality of second cells, each cell of the plurality of second cells having a corresponding second occupancy probability and second velocity; and
determine a dynamic occupancy grid by analyzing the at least one radar-based occupancy grid and the at least one camera-based occupancy grid.

Clause 44. The non-transitory, processor-readable storage medium of clause 43, wherein the processor-readable instructions to cause the processor to determine the dynamic occupancy grid comprise processor-readable instructions to cause the processor to:
set the second velocity to a non-zero default velocity for each of the plurality of second cells occupied by an object classified as a vehicle; and
set the second velocity to zero for each of the plurality of second cells that is either unoccupied or occupied by an object classified as a static object.

Clause 45. The non-transitory, processor-readable storage medium of clause 43, further comprising processor-readable instructions to cause the processor to determine the at least one radar-based occupancy grid and the at least one camera-based occupancy grid.

Clause 46. The non-transitory, processor-readable storage medium of clause 45, further comprising processor-readable instructions to cause the processor to wait for sensor data from all of a plurality of radar sensors of the apparatus and all of at least one camera of the apparatus, or expiration of a sensor data collection time interval, before determining the at least one radar-based occupancy grid and the at least one camera-based occupancy grid.

Clause 47. The non-transitory, processor-readable storage medium of clause 46, further comprising processor-readable instructions to cause the processor to determine the sensor data collection time interval as a function of speed of the apparatus.

Clause 48. The non-transitory, processor-readable storage medium of clause 43, further comprising processor-readable instructions to cause the processor to fuse the at least one radar-based occupancy grid and the at least one camera-based occupancy grid to determine a fused occupancy grid.

Clause 49. The non-transitory, processor-readable storage medium of clause 48, wherein the processor-readable instructions to cause the processor to fuse the at least one radar-based occupancy grid and the at least one camera-based occupancy grid comprise processor-readable instructions to cause the processor to fuse the at least one radar-based occupancy grid and the at least one camera-based occupancy grid only if most-recent available camera sensor data and most-recent available radar sensor data correspond to a same sensor data collection time interval.

Clause 50. The non-transitory, processor-readable storage medium of clause 48, wherein the processor-readable instructions to cause the processor to fuse the at least one radar-based occupancy grid and the at least one camera-based occupancy grid comprise processor-readable instructions to cause the processor to use, for a fused occupancy grid cell, a reference velocity of a reference occupancy grid cell, corresponding to the fused occupancy grid cell, based on:
a camera-based occupancy probability of a camera-based occupancy grid cell, corresponding to the reference occupancy grid cell, being greater than a reference occupancy probability of the reference occupancy grid cell; and
an indication that the camera-based occupancy grid cell is occupied by a vehicle.

Clause 51. The non-transitory, processor-readable storage medium of clause 48, further comprising processor-readable instructions to cause the processor to set a dynamic probability of a fused occupancy grid cell of the fused occupancy grid to a non-zero value and a static probability of the fused occupancy grid cell of the fused occupancy grid to zero based on an indication that a camera-based occupancy probability corresponding to the fused occupancy grid cell was higher than a radar-based occupancy probability corresponding to the fused occupancy grid cell.

Clause 52. The non-transitory, processor-readable storage medium of clause 48, wherein the processor-readable instructions to cause the processor to fuse the at least one radar-based occupancy grid and the at least one camera-based occupancy grid comprise processor-readable instructions to cause the processor to:
determine at least one radar-based fused measurement grid each corresponding to a respective one of the at least one radar-based occupancy grid by fusing the respective one of the at least one radar-based occupancy grid and first occupancy coefficients;
determine at least one camera-based fused measurement grid each corresponding to a respective one of the at least one camera-based occupancy grid by fusing the respective one of the at least one camera-based occupancy grid and second occupancy coefficients; and
fuse the at least one radar-based fused measurement grid and the at least one camera-based fused measurement grid to determine an updated fused measurement grid.

Clause 53. The non-transitory, processor-readable storage medium of clause 52, wherein the processor-readable instructions to cause the processor to fuse the at least one radar-based fused measurement grid and the at least one camera-based fused measurement grid comprise processor-readable instructions to cause the processor to apply the Dempster-Shafer theory.

Clause 54. The non-transitory, processor-readable storage medium of clause 52, wherein the processor-readable instructions to cause the processor to fuse the at least one radar-based fused measurement grid and the at least one camera-based fused measurement grid comprise processor-readable instructions to cause the processor to soft weight respective velocities of the at least one radar-based fused measurement grid and the at least one camera-based fused measurement grid.

Clause 55. The non-transitory, processor-readable storage medium of clause 52, wherein the processor-readable instructions to cause the processor to fuse the at least one radar-based fused measurement grid and the at least one camera-based fused measurement grid comprise processor-readable instructions to cause the processor to set a velocity of a cell of the updated fused measurement grid to zero based on a camera-based classification of the cell being other than a dynamic object.

Clause 56. The non-transitory, processor-readable storage medium of clause 52, wherein the processor-readable instructions to cause the processor to fuse the at least one radar-based fused measurement grid and the at least one camera-based fused measurement grid comprise processor-readable instructions to cause the processor to set a velocity of a cell of the updated fused measurement grid to a radar-based velocity based on at least one velocity of the at least one radar-based fused measurement grid based on a camera-based classification of the cell being indicative of a dynamic object.

### Other Considerations

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. Thus, reference to a device in the singular (e.g., “a device,” “the device”), including in the claims, includes at least one, i.e., one or more, of such devices (e.g., “a processor” includes at least one processor (e.g., one processor, two processors, etc.), “the processor” includes at least one processor, “a memory” includes at least one memory, “the memory” includes at least one memory, etc.). The phrases “at least one” and “one or more” are used interchangeably and such that “at least one” referred-to object and “one or more” referred-to objects include implementations that have one referred-to object and implementations that have multiple referred-to objects. For example, “at least one processor” and “one or more processors” each includes implementations that have one processor and implementations that have multiple processors. Also, a “set” as used herein includes one or more members, and a “subset” contains fewer than all members of the set to which the subset refers.

The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, a list of items prefaced by “at least one of” or prefaced by “one or more of” indicates a disjunctive list such that, for example, a list of “at least one of A, B, or C,” or a list of “at least one of A, B, and C,” or a list of “one or more of A, B, or C”, or a list of “one or more of A, B, and C,” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of +20% or +10%, +5%, or +0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or ±0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

The invention claimed is:

1. An apparatus comprising:
at least one memory; and
at least one processor communicatively coupled to the at least one memory and configured to:
obtain at least one radar-based occupancy grid based on radar sensor measurements, each of the at least one radar-based occupancy grid comprising a plurality of first cells, each cell of the plurality of first cells having a corresponding first occupancy probability and first velocity;
obtain at least one camera-based occupancy grid based on camera measurements, each of the at least one camera-based occupancy grid comprising a plurality of second cells, each cell of the plurality of second cells having a corresponding second occupancy probability and second velocity; and
determine a dynamic occupancy grid by analyzing the at least one radar-based occupancy grid and the at least one camera-based occupancy grid.

2. The apparatus of claim 1, wherein to determine the dynamic occupancy grid the at least one processor is configured to:
set the second velocity to a non-zero default velocity for each of the plurality of second cells occupied by an object classified as a vehicle; and
set the second velocity to zero for each of the plurality of second cells that is either unoccupied or occupied by an object classified as a static object.

3. The apparatus of claim 1, wherein the at least one processor is configured to determine the at least one radar-based occupancy grid and the at least one camera-based occupancy grid.

4. The apparatus of claim 3, wherein the at least one processor is configured to wait for sensor data from all of a plurality of radar sensors of the apparatus and all of at least one camera of the apparatus, or expiration of a sensor data collection time interval, before determining the at least one radar-based occupancy grid and the at least one camera-based occupancy grid.

5. The apparatus of claim 4, wherein the at least one processor is configured to determine the sensor data collection time interval as a function of speed of the apparatus.

6. The apparatus of claim 1, wherein the at least one processor is configured to fuse the at least one radar-based occupancy grid and the at least one camera-based occupancy grid to determine a fused occupancy grid.

7. The apparatus of claim 6, wherein the at least one processor is configured to fuse the at least one radar-based occupancy grid and the at least one camera-based occupancy grid only if most-recent available camera sensor data and most-recent available radar sensor data correspond to a same sensor data collection time interval.

8. The apparatus of claim 6, wherein to fuse the at least one radar-based occupancy grid and the at least one camera-based occupancy grid, the at least one processor is configured to use, for a fused occupancy grid cell, a reference velocity of a reference occupancy grid cell, corresponding to the fused occupancy grid cell, based on:
a camera-based occupancy probability of a camera-based occupancy grid cell, corresponding to the reference occupancy grid cell, being greater than a reference occupancy probability of the reference occupancy grid cell; and
an indication that the camera-based occupancy grid cell is occupied by a vehicle.

9. The apparatus of claim 6, wherein the at least one processor is configured to set a dynamic probability of a fused occupancy grid cell of the fused occupancy grid to a non-zero value and a static probability of the fused occupancy grid cell of the fused occupancy grid to zero based on an indication that a camera-based occupancy probability corresponding to the fused occupancy grid cell was higher than a radar-based occupancy probability corresponding to the fused occupancy grid cell.

10. The apparatus of claim 6, wherein to fuse the at least one radar-based occupancy grid and the at least one camera-based occupancy grid the at least one processor is configured to:
determine at least one radar-based fused measurement grid each corresponding to a respective one of the at least one radar-based occupancy grid by fusing the respective one of the at least one radar-based occupancy grid and first occupancy coefficients;
determine at least one camera-based fused measurement grid each corresponding to a respective one of the at least one camera-based occupancy grid by fusing the respective one of the at least one camera-based occupancy grid and second occupancy coefficients; and
fuse the at least one radar-based fused measurement grid and the at least one camera-based fused measurement grid to determine an updated fused measurement grid.

11. The apparatus of claim 10, wherein to fuse the at least one radar-based fused measurement grid and the at least one camera-based fused measurement grid the at least one processor is configured to apply the Dempster-Shafer theory.

12. The apparatus of claim 10, wherein to fuse the at least one radar-based fused measurement grid and the at least one camera-based fused measurement grid the at least one processor is configured to soft weight respective velocities of the at least one radar-based fused measurement grid and the at least one camera-based fused measurement grid.

13. The apparatus of claim 10, wherein to fuse the at least one radar-based fused measurement grid and the at least one camera-based fused measurement grid the at least one processor is configured to set a velocity of a cell of the updated fused measurement grid to zero based on a camera-based classification of the cell being other than a dynamic object.

14. The apparatus of claim 10, wherein to fuse the at least one radar-based fused measurement grid and the at least one camera-based fused measurement grid the at least one processor is configured to set a velocity of a cell of the updated fused measurement grid to a radar-based velocity based on at least one velocity of the at least one radar-based fused measurement grid based on a camera-based classification of the cell being indicative of a dynamic object.

15. A dynamic occupancy grid determination method comprising:
obtaining, at an apparatus, at least one radar-based occupancy grid based on radar sensor measurements, each of the at least one radar-based occupancy grid comprising a plurality of first cells, each cell of the plurality of first cells having a corresponding first occupancy probability and first velocity;
obtaining, at the apparatus, at least one camera-based occupancy grid based on camera measurements, each of the at least one camera-based occupancy grid comprising a plurality of second cells, each cell of the plurality of second cells having a corresponding second occupancy probability and second velocity; and
determining, at the apparatus, a dynamic occupancy grid by analyzing the at least one radar-based occupancy grid and the at least one camera-based occupancy grid.

16. The dynamic occupancy grid determination method of claim 15, wherein determining the dynamic occupancy grid comprises:
setting the second velocity to a non-zero default velocity for each of the plurality of second cells occupied by an object classified as a vehicle; and
setting the second velocity to zero for each of the plurality of second cells that is either unoccupied or occupied by an object classified as a static object.

17. The dynamic occupancy grid determination method of claim 15, further comprising determining the at least one radar-based occupancy grid and the at least one camera-based occupancy grid.

18. The dynamic occupancy grid determination method of claim 17, further comprising waiting for sensor data from all of a plurality of radar sensors of the apparatus and all of at least one camera of the apparatus, or expiration of a sensor data collection time interval, before determining the at least one radar-based occupancy grid and the at least one camera-based occupancy grid.

19. The dynamic occupancy grid determination method of claim 18, further comprising determining the sensor data collection time interval as a function of speed of the apparatus.

20. An apparatus comprising:
means for obtaining at least one radar-based occupancy grid based on radar sensor measurements, each of the at least one radar-based occupancy grid comprising a plurality of first cells, each cell of the plurality of first cells having a corresponding first occupancy probability and first velocity;
means for obtaining at least one camera-based occupancy grid based on camera measurements, each of the at least one camera-based occupancy grid comprising a plurality of second cells, each cell of the plurality of second cells having a corresponding second occupancy probability and second velocity; and
means for determining a dynamic occupancy grid by analyzing the at least one radar-based occupancy grid and the at least one camera-based occupancy grid.
